(19) United States
(12) Patent Application Publication
(10) Pub. No.: US 2026/0331411 A1
(43) Pub. Date: Oct. 22, 2026

(54) PACKAGE INCLUDING FIELD EMISSION ELEMENT AND METHOD OF MANUFACTURING THE SAME

(71) Applicant: LG ELECTRONICS INC., Seoul (KR)

(72) Inventors: Giwon LEE, Seoul (KR); Hyojin NAM, Seoul (KR); Byungkee LEE, Seoul (KR); Jinah KIM, Seoul (KR); Youngsik KIM, Seoul (KR); Eunju HONG, Seoul (KR)

(73) Assignee: LG ELECTRONICS INC., Seoul (KR)

(21) Appl. No.: 19/652,909

(22) Filed: Apr. 20, 2026

(30) Foreign Application Priority Data
Apr. 22, 2025 (WO) PCT/KR2025/095272

(51) Int. Cl. H01J 1/304; H01J 1/308; H01J 9/02

(52) U.S. Cl. CPC H01J 1/3044; H01J 1/308; H01J 9/025; H01J 2201/30411

(57) ABSTRACT

Proposed is a package including a field emission element, the package including a silicon substrate, a doped region formed on one surface of the silicon substrate and doped with dopants, a plurality of probes formed at the doped region and grouped in regions along a first axial direction and a second axial direction of the silicon substrate, an insulating layer formed at the doped region and surrounding the plurality of probes, a gate electrode formed at an upper surface of the insulating layer, and an isolation region formed in the doped region in a depth direction of the doped region and configured to prevent overcurrent from being concentrated on the probes due to movement of electrons along horizontal directions of the silicon substrate and to prevent element destruction caused by the overcurrent.

### CROSS-REFERENCE TO RELATED APPLICATION

Pursuant to 35 U.S.C. § 119, this application claims the benefit of an earlier filing date and right of priority to International Application No. PCT/KR2025/095272, filed on Apr. 22, 2025, the contents of which are hereby incorporated by reference herein in its entirety.

### BACKGROUND

The present disclosure relates to a package including a field emission element. More particularly, the present disclosure relates to a package including a field emission element and a method of manufacturing the package.

In a probe-type field emission element, the field emission current density is highly sensitive to geometrical parameters (including parameters such as height and radius) of a probe. Particularly, the probe radius is on the order of several nanometers, and even slight variations in the radius can result in a significant increase in the probe current density. Therefore, deformation of the probe shape or micro arc plasma may result in an electrical short circuit to the gate electrode, thereby causing a severe reliability concern.

Various methods have been proposed to achieve a high current density while maintaining reliability. Nevertheless, complete elimination of a reliability problem caused by arcing is highly difficult.

In the case of a silicon probe, since the probe is fabricated by etching a silicon wafer, there is a problem in that it is difficult to form an additional resistance layer beneath the probe, and accordingly, no current-limiting resistance layer has been reported.

For n-type silicon, in which electrons are the majority carriers, high current density can be achieved. However, it is difficult to avoid an arcing phenomenon due to local plasma generation, which poses a problem in securing reliability.

In order to ensure reliability, a silicon emitter may be fabricated from a p-type wafer in which holes are the majority carriers, or may employ a p-n junction structure. In this case, high reliability may be achieved; however, the limited availability of electrons for emission restricts the current density, thus high current operation may not be achieved.

As a method for ensuring reliability and overcoming current density limitations, transistors such as MOSFETs and JFETs can be fabricated with the transistor gate voltage being adjustable to control the current. However, the fabrication process is complex, and transistor formation requires additional area, which results in reduced probe density.

### SUMMARY

One object of the present disclosure is to provide a package including a field emission element and a method of manufacturing the package to address the above described issues.

Another object of the present disclosure is to ensure reliability by preventing overcurrent from passing through some probes.

A further object of the present disclosure is to prevent emission current from being concentrated on some probes when a field emission element is in operation.

Another object of the present disclosure is to increase element reliability by preventing emission current from being concentrated on some probes when a field emission element is in operation.

According to an aspect of the present disclosure, there is provided a package including a field emission element, the package including: a silicon substrate; a doped region formed on one surface of the silicon substrate and doped with dopants; a plurality of probes formed at the doped region and grouped in regions along a first axial direction and a second axial direction of the silicon substrate; an insulating layer formed at the doped region and surrounding the plurality of probes; a gate electrode formed at an upper surface of the insulating layer; and an isolation region formed in the doped region in a depth direction of the doped region and configured to prevent overcurrent from being concentrated on the probes due to movement of electrons along horizontal directions of the silicon substrate and to prevent element destruction caused by the overcurrent.

According to an embodiment, in the package, the isolation region may be formed in a grid structure extending along one axial direction and the other axial direction of the silicon substrate. The lattice structure may be formed to partition the doped region in which the probes are formed.

According to an embodiment, in the package, the isolation region may be formed to extend into the doped region and the silicon substrate in a depth direction of the package.

According to an embodiment, in the package, the doped region may be formed on the upper surface of the silicon substrate in such a manner as to have a first thickness. The isolation region may be formed to extend into the doped region in such a manner as to have a second thickness greater than the first thickness.

According to an embodiment, in the package, the silicon substrate may be formed as a p-type silicon substrate doped with p-type dopants at a first dopant concentration. The doped region may be formed as an n-type doped region doped with n-type dopants at a second dopant concentration. The isolation region may be formed to be doped with p-type dopants at a third dopant concentration. The third dopant concentration may be higher than the second dopant concentration.

According to an embodiment, in the package, the isolation region may be formed as an insulator with which a trench structure, extending into the doped region in such a manner as to have the second thickness greater than the first thickness, is filled. The doped region may be formed to be doped with dopants of a conductivity type different from that of the silicon substrate.

According to an embodiment, in the package, the doped region may be formed to have a p-type dopant concentration lower than that of the silicon substrate. The probers may be formed in such a manner that an n-type dopant concentration of each of the upper regions thereof is higher than that of each of the lower regions thereof.

According to an embodiment, in the package, the doped region may include: a first semiconductor layer formed on top of the silicon substrate in such a manner as to be doped with p-type dopants at a fourth dopant concentration lower than a first dopant concentration of the silicon substrate; an intrinsic semiconductor layer arranged on top of the first semiconductor layer; and a third semiconductor layer formed on top of the intrinsic semiconductor layer in such a manner as to be doped with n-type dopants at a second dopant concentration.

According to an embodiment, in the package, the second dopant concentration may be higher than the first dopant concentration. The probes may be formed in such a manner that an n-type dopant concentration of each of the upper regions thereof is higher than that of each of the lower regions thereof.

According to an embodiment, in the package, the isolation region may be formed in such a manner that the width thereof ranges from 1 μm to 1 mm. The isolation region may be formed in such a manner that a second thickness thereof ranges from 1 nm to 100 μm. The width of the isolation region may be greater than the second thickness of the isolation region.

According to an embodiment, in the package, the probes may be arranged in a first probe region adjacent to one boundary of the isolation region in the one axial direction and the other axial direction. The probes may be arranged in a second probe region adjacent to the other boundary of the isolation region in the one axial direction and the other axial direction. The isolation region may be formed in such a manner that the width thereof is smaller than the distance between adjacent probes among the probes.

According to an embodiment, in the package, the isolation region may include a first isolation region formed in the central region of the silicon substrate and a second isolation region formed in the surrounding region of the silicon substrate. The first isolation region may be formed in such a manner that a first width thereof is greater than a second width of the second isolation region. The first isolation region may be formed in such a manner that a second thickness thereof is greater than a third thickness of the second isolation region.

According to another aspect of the present disclosure, there is provided a method of forming a package including a field emission element, the method includes: forming a doped region at a surface of a silicon substrate to be doped with dopants; arranging mask patterns in regions of the doped region; forming, by etching the doped region, a plurality of probes to be arranged in groups in the regions and arranged along a first axial direction and a second axial direction of the silicon substrate; forming an isolation region between the groups of probes; forming an insulating layer to surround the plurality of probes; and forming a gate electrode at an upper surface of the insulating layer.

According to an embodiment, in the method, in the forming of the doped region, the doped region may be formed on the upper surface of the silicon substrate in such a manner as to have a first thickness. In the forming of the isolation region, the isolation region may be formed to extend into the doped region and the silicon substrate in a depth direction of the package in such a manner as to have a second thickness greater than the first thickness.

According to an embodiment, in the method, in the forming of the doped region, the doped region may be formed to be doped with dopants of a conductive type different from that of the silicon substitute. The forming of the isolation region may include: forming a trench structure that extends into the doped region in such a manner as to have the second thickness greater than the first thickness and forming an insulator by filling the trench structure, having the second thickness, with an insulating material.

According to an embodiment, in the method, the silicon substrate may be formed as a p-type silicon substrate doped with p-type dopants at a first dopant concentration. The doped region may be formed as an n-type doped region doped with n-type dopants at a second dopant concentration. In the forming of the isolation region, the isolation region may be formed to be doped with p-type dopants at a third dopant concentration. The second length may be formed such that it is greater than the first length.

According to an embodiment, the method may further include, after the forming of the gate electrode, doping the plurality of probes with n-type dopants. The doped region formed during the forming of the doped region may include a p- layer having a p-type dopant concentration lower than that of the silicon substrate. In the forming of the plurality of probes, the plurality of probes may be formed to have the same conductivity type as either the p- layer in the doped region or the silicon substrate. In the doping of the plurality of probes, the plurality of probes may be formed in such a manner that an n-type dopant concentration of each of the upper regions thereof is higher than that of an n layer region beneath the insulating layer.

According to an embodiment, in the method, the forming of the doped region may include: forming a first semiconductor layer formed on top of the silicon substrate in such a manner as to be doped with p-type dopants at a fourth dopant concentration lower than a first dopant concentration of the silicon substrate; forming an intrinsic semiconductor layer on top of the first semiconductor layer; and forming a third semiconductor layer on top of the intrinsic semiconductor in such a manner as to be doped with n-type dopants at a second dopant concentration. The second dopant concentration may be higher than the first dopant concentration. In the forming of the plurality of probes, the plurality of probes may be formed in such a manner that an n-type dopant concentration of each of the upper regions thereof is higher than that of each of the lower regions thereof.

According to an embodiment, in the method, in the forming of the isolation region, the isolation region may be formed in such a manner that the width thereof ranges from 1 μm to 1 mm, and the isolation region may be formed in such a manner that a second thickness thereof ranges from 1 nm to 100 μm. The isolation region may be formed in such a manner that the width of the isolation region is greater than the second thickness of the isolation region. In the forming of the isolation region, the probes may be arranged in a first probe region adjacent to one boundary of the isolation region in the one axial direction and the other axial direction, and the probes may be arranged in a second probe region adjacent to the other boundary of the isolation region in the one axial direction and the other axial direction. The isolation region may be formed in such a manner that the width thereof is smaller than the distance between adjacent probes among the probes.

According to an embodiment, in the method, the forming of the isolation region may include: forming a first isolation region in the central region of the silicon substrate; and forming a second isolation region in the surrounding region of the silicon substrate. The first isolation region may be formed in such a manner that a first width thereof is greater than a second width of the second isolation region. The first isolation region may be formed in such a manner that a second thickness thereof is greater than a third thickness of the second isolation region.

According to a further aspect of the present disclosure, there is provided a package including a field emission element, the package being manufactured using a method of manufacturing the package, and the package including: a doped region formed on one surface of a silicon substrate in a doped region formation step in such a manner as to be doped with dopants, mask patterns being arranged in portions, respectively, of the doped region in a mask pattern arrangement step in such a manner that a plurality of probes are formed in the portions, respectively, of the doped region; the plurality of probes formed in portions, respectively, of the doped region in one axial direction and the other axial direction of the silicon substrate by etching the doped region, in a probe formation step; an isolation region formed in the doped region on top of the silicon substrate, the portion corresponding to a region between the plurality of probes, in an isolation region formation step; an insulating layer formed in the doped region in such a manner as to surround the plurality of probes, in an insulating layer formation step; and a gate electrode formed on the upper surface of the insulating layer in a gate electrode formation step. The isolation region may be formed to prevent overcurrent from being concentrated on the probes due to movement of electrons along the horizontal direction of the silicon substrate, or to prevent element destruction caused by the overcurrent.

According to another aspect of the present disclosure, there is provided a package including a field emission element, the package being manufactured using a method of manufacturing the package, and the package including: a doped region formed on one surface of a silicon substrate in a doped region formation step in such a manner as to be doped with dopants, mask patterns being arranged in portions, respectively, of the doped region in a mask pattern arrangement step in such a manner that a plurality of probes are formed in the portions, respectively, of the doped region; an isolation region formed in the doped region on top of the silicon substrate, the portion corresponding to a region between the plurality of probes, in an isolation region formation step; the plurality of probes formed in portions, respectively, of the doped region in one axial direction and the other axial direction of the silicon substrate by etching the doped region, in a probe formation step; an insulating layer formed in the doped region in such a manner as to surround the plurality of probes, in an insulating layer formation step; and a gate electrode formed on the upper surface of the insulating layer in a gate electrode formation step. The isolation region may be formed to prevent overcurrent from being concentrated on the probes due to movement of electrons along the horizontal direction of the silicon substrate, or to prevent element destruction caused by the overcurrent.

According to the present disclosure, a package including a field emission element and a method of manufacturing the same can be provided.

According to the present disclosure, because emission current is concentrated on silicon tip-shaped probes, element destruction can be prevented.

According to the present disclosure, a doped region serving as a counter-doped layer can be arranged on top of a silicon substrate, thereby increasing the emission current of the field emission element even under low emission conditions.

According to the present disclosure, the doped region is formed on top of the silicon substrate, and an isolation region formed in a portion of the doped region can extend to a predetermined depth into the silicon substrate, thereby structurally preventing the emission current from being concentrated on probes.

According to the present disclosure, by optimally forming the doped region and the isolation region, a short circuit from a gate electrode to a cathode electrode and thermal breakdown can be prevented.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1(a) includes a cross-sectional view illustrating an n-type field emission element in the related art and FIG. 1(b) includes a graph illustrating current-voltage characteristics thereof;

FIG. 2(a) includes a cross-sectional view illustrating a p-type field emission element in the related art, FIG. 2(b) includes an an energy band diagram, and FIG. 2(c) includes a graph illustrating current-voltage characteristics thereof;

FIG. 3 is a front view illustrating a package including a field emission element according to an embodiment of the present disclosure;

FIGS. 4 and 5 are cross-sectional views, each illustrating the package having an isolation region, a package including the field emission element of FIG. 3;

FIG. 6(a) and 6(b) include cross-sectional views illustrating the package that includes a doped region formed as at least one layer according to embodiments of the present disclosure;

FIG. 7 is a graph illustrating doping profile simulation results for the package in which an n/i/p- layer structure is formed through ion implantation according to an embodiment of the present disclosure;

FIG. 8 illustrates emission current-voltage characteristics according to an implantation dose during ion implantation that uses n-type dopants according to an embodiment of the present disclosure.

FIG. 9 is a cross-sectional view illustrating an example of the package that includes the field emission element having the p-/i/n layer structure;

FIG. 10 is a front view illustrating the package including a first isolation region and a second isolation region, according to an embodiment of the present disclosure;

FIG. 11(a) and 11(b) include cross-sectional views illustrating the package of FIG. 9, which includes either a p- layer along, or a p- layer, an i layer, and an n layer, according to embodiments of the present disclosure;

FIG. 12 is a flowchart illustrating a method of manufacturing the package that includes the field emission element according to an embodiment of the present disclosure;

FIG. 13(a) and 13(b) include cross-sectional views illustrating an example of the package manufactured by performing in the manufacturing method of FIG. 12;

FIG. 14(a) and 14(b) include cross-sectional views illustrating an example of the package that is manufactured by doping p-type probes with n-type dopants;

FIG. 15(a) includes a cross-sectional view illustrating an example of the package before an isolation region has been formed and 15(b) and 15(c) include two cross-sectional views illustrating examples of the package after the isolation region has been formed;

FIG. 16(a) includes one cross-sectional view illustrating an example of the package after an isolation region has been formed and before a probe region is formed, and 16(b) and 16(b) include two cross-sectional views illustrating examples of the package after the probe region has been formed; and

FIG. 17(a) includes one cross-sectional view illustrating an example of the package before the isolation region with a trench structure has been formed and before the probe region is formed and 17(b) and 17(c) include two cross-sectional views illustrating examples of the package after the probe region has been formed.

### DETAILED DESCRIPTION OF THE EMBODIMENTS

The technology disclosed in the present specification is applicable to a package including a field emission element, and an X-ray apparatus. However, the technology disclosed in the present disclosure is not limited thereto, and is also applicable to packages including field emission elements to which the technical idea behind the technology is applicable and to X-ray apparatuses that include such packages.

Technical terms used in the present specification are intended solely to describe specific embodiments and are not intended to limit the present disclosure. In addition, unless otherwise specifically defined, the technical terms used in the present specification should be construed as having the meanings generally understood by those of ordinary skill in the art to which the present disclosure pertains. These terms should not be construed either too broadly or too narrowly. In addition, when the technical term used in the present specification does not precisely reflect the technical concept of the present disclosure, it should be construed to have the meaning generally accepted by those of ordinary skill in the art. In addition, general terms used in the present specification should be interpreted based on their standard dictionary meanings or as understood within the context of this disclosure, without applying an unduly narrow construction.

In addition, terms expressed in the singular form in the present specification should be construed to include the plural form unless the context clearly dictates otherwise. Throughout the present specification, the terms such as ‘is configured to include’ or ‘includes’ should not be construed as requiring all constituent elements or all steps described herein. Rather, these terms should be construed to allow for the omission of one or more elements or steps, as well as the inclusion of one or more additional elements or steps.

The terms "module" and "unit" that will be used in the following description are coined and interchangeably used, considering only ease of description in the specification, and themselves are not intended to have different meanings and interpretations.

In addition, expressions of ordinal numbers, including ‘first,’ ‘second,’ and similar, are employed for the sake of identification and convenience in description only, and are not to be construed as limiting the elements to any specific order or hierarchy. These terms are used merely to distinguish among constituent elements having similar functions. For example, a first constituent element may be referred to as a second constituent element without departing from the scope of claims. Similarly, the second constituent element may be referred to as the first constituent element.

Preferred embodiments according to the present disclosure are described below with reference to the accompanying drawings. Like constituent elements are designated by like-reference numerals throughout the drawings, and redundant descriptions thereof are omitted.

In addition, a detailed description of known technologies associated with the present disclosure may be omitted where such description is deemed likely to obscure or detract from the clarity of the present disclosure. In addition, the accompanying drawings are provided solely to facilitate understanding of the technical idea disclosed in the present specification. It should be noted that the accompanying drawings are not construed as imposing any limitation on the underlying technical idea.

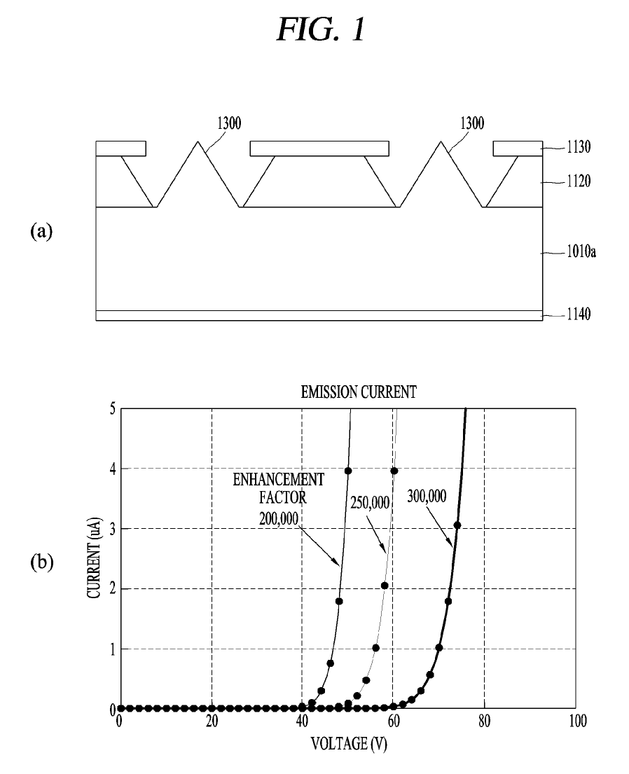

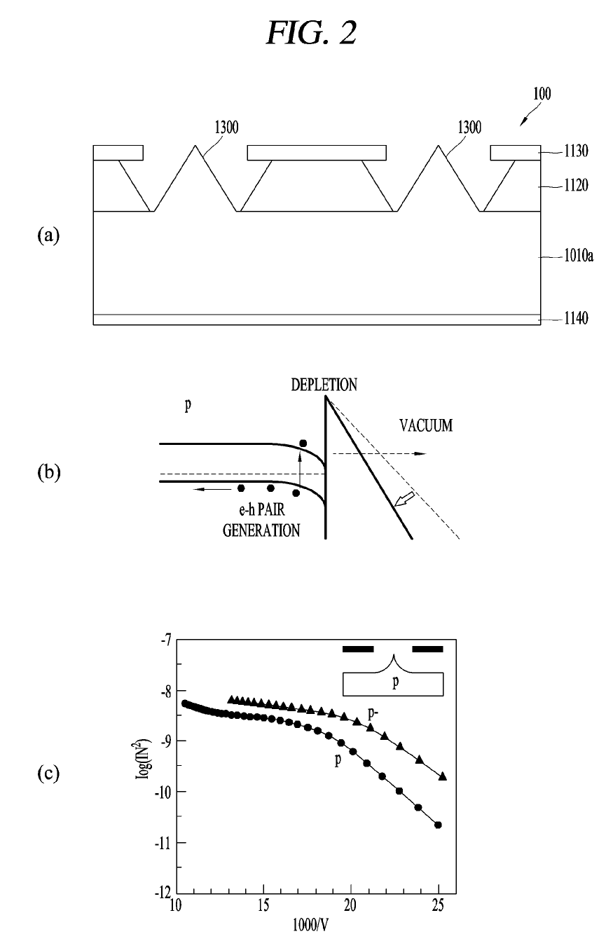

FIG. 1 includes a cross-sectional view illustrating an n-type field emission element in the related art and a graph illustrating current-voltage characteristics thereof. FIG. 2 includes a cross-sectional view illustrating a p-type field emission element in the related art, an energy band diagram, and a graph illustrating current-voltage characteristics thereof.

(a) of FIG. 1 is a cross-sectional view illustrating the n-type field emission element. (b) of FIG. 1 is a graph illustrating the current-voltage characteristics of the n-type field emission element in (a) of FIG. 1. With reference to (a) of FIG. 1, a plurality of probes 1300 are formed as protrusions, collectively referred to as a probe portion, through etching. An insulating layer 1120 may be formed between the plurality of probes 1300. A gate electrode 1130 may be formed on top of the insulating layer 1120.

A first electrode 1140, which is a cathode electrode, may be formed beneath an n-type silicon substrate 1010a. When a voltage is applied between the first electrode 1140 and the gate electrode 1130, an electric field is concentrated on the probes 1300, each being formed to have a sharp tip. Accordingly, a tunnel barrier in a vacuum becomes thinner. Thus, electrons from the probes 1300, each being formed to have a sharp tip, are emitted into the vacuum as a result of a tunneling phenomenon.

(b) of FIG. 1 illustrates the voltage-current characteristics of the field emission element. It can be seen from (b) of FIG. 1 that current changes with high sensitivity to voltage and the field multiplication factor, for example, in a manner similar to that of an exponential function.

The voltage may be adjusted consistently, but it is extremely difficult to maintain the field multiplication factor at a consistent level. The field multiplication factor varies depending on the radius of the probe 1300, and it is almost impossible to maintain the radius of the probe uniformly at the level of several nanometers. In addition, the field multiplication factor changes with high sensitivity to the surface contamination level, among other factors. Therefore, even when the same voltage is applied to the individual probes, there is a significant difference in the resulting current. Therefore, even in a state where electron emission does not occur at a specific probe 1300, excessive current may cause arcing at another probe portion. Accordingly, an electrical short circuit to the gate electrode may occur, or degradation of reliability may occur.

As described above, a silicon-based field emission element may be fabricated using an n-type silicon substrate where electrons act as majority carriers. However, in the field emission element fabricated using the n-type silicon substrate, the current may be concentrated on a specific tip due to a difference in the field enhancement factor among the individual tips, thereby causing arcing. Therefore, arcing causes defects, resulting in a serious reliability issue. To address this reliability issue, an electron emission element fabricated using a p-type silicon substrate where electrons act as minority carriers may be employed to limit current.

For a field emission element according to the present disclosure, it is necessary to prevent arcing. To this end, a field emission element, such as a diode-type element or a transistor-type element, may be considered. (a) of FIG. 2 is a cross-sectional view illustrating a field emission element fabricated using a p-type silicon substrate. (b) and (c) of FIG. 2 are an energy band diagram and a Flower-Nordheim (F-N) graph, respectively, that are associated with the field emission element fabricated using the p-type silicon substrate.

With reference to FIG. 2, the probes 1300 may be formed by etching a p-type silicon substrate 1010b. An n-type silicon substrate 1010a may be formed using the p-type silicon substrate. The insulating layer 1120 may be formed between the probes 1300. The gate electrode 1130 may be formed on top of the insulating layer 1120. A cathode electrode 1140 may be formed beneath the p-type silicon substrate 1010b.

In the p-type silicon substrate 1010b, electrons act as minority carriers, thereby limiting the supply thereof and thus limiting excessive current flow through the probe 1300. With reference to the energy band diagram in (b) of FIG. 2, a depletion layer is generated in the boundary region. Electron-hole pairs, resulting from thermal generation in the depletion region, are the primary source of electrons. Therefore, if electrical resistance is high, the depletion region may increase in size, thereby increasing current. It can be seen from the F-N graph in (c) of FIG. 2 that the F-N emission characteristic appears at low voltages while, at high voltages, the restriction of electron supply by the p-type silicon substrate 1010 limits the current.

Arcing may be prevented by suppressing the flow of high current through the probes 1300 in this manner. However, limitations exist in obtaining the high current required by the field emission element because of the restriction of electron supply.

In this regard, a probe-type field emission element fabricated using the p-type silicon substrate 1010b has a structure that results from forming the probe 1300 by etching the p-type silicon substrate 1010b and subsequently forming the insulating layer 1120 and the gate electrode 1130. When a voltage is applied between the bottom electrode (or the cathode) and the gate electrode, an electric field is concentrated on the sharp probe 1300. As a result, the tunnel barrier in the vacuum becomes thinner. Therefore, electrons from the probe 1300 are emitted into the vacuum as a result of the tunneling phenomenon.

This structure is employed in the field emission element that utilizes electrons acting as minority carriers in the p-type silicon substrate 1010b. Current is limited by the electrons generated in the depletion layers at the surface and interface of the silicon substrate, thereby achieving an effect of preventing arcing. However, a sufficient emission current required for an X-ray tube cannot be obtained.

A package including the field emission element according to the present disclosure is described below. FIG. 2 illustrates a package 100 of a field emission element in which a doped region is not separately formed on the p-type silicon substrate 1010b. The package 100 of the field emission element, in which the doped region is not formed, may maintain the stability of the element under a low operating current because of a low emission current. However, in a case where a high gate voltage is applied for the emission current, a problem arises in that the stability of the element decreases.

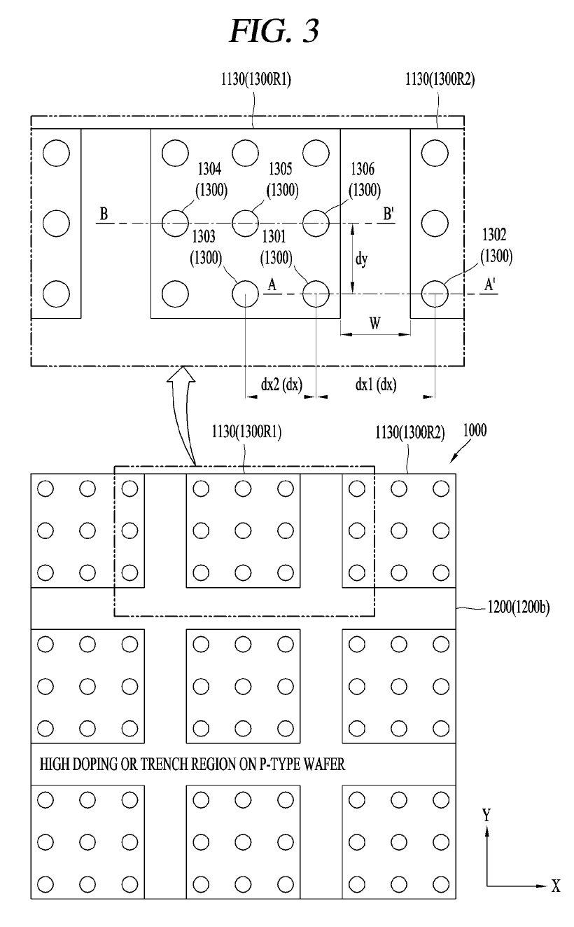

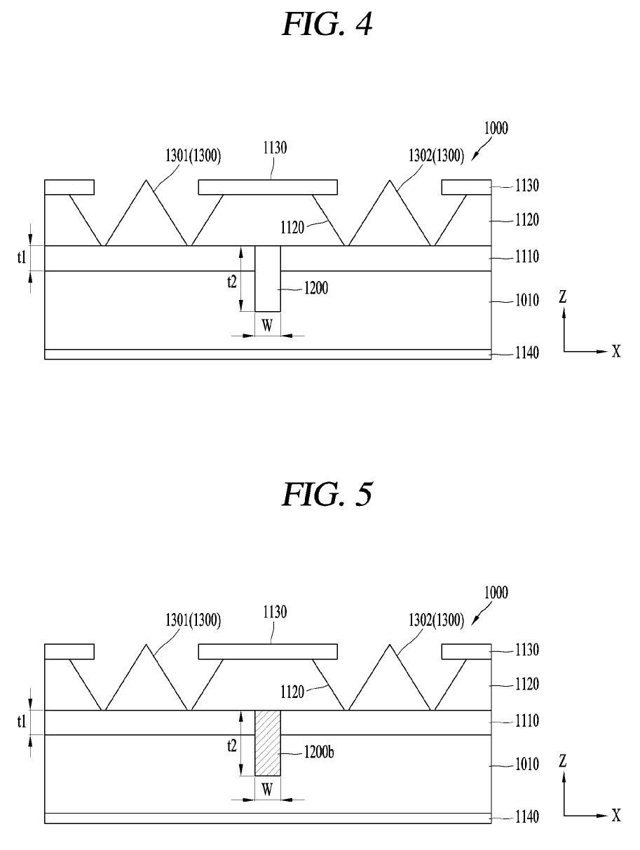

FIG. 3 is a front view illustrating the package 100 including the field emission element according to the present disclosure. FIGS. 4 and 5 are cross-sectional views, each illustrating the package 100 having an isolation region, the package including the field emission element in FIG. 3. FIGS. 4 and 5 are also cross-sectional views taken along line AA’ in the front view illustrating a package 1000 that includes the field emission element in FIG. 3.

With reference to FIGS. 3-5, the package 1000 including the field emission element according to the present disclosure is described. In the package 1000, the p-type silicon substrate 1010 is arranged beneath the plurality of probes 1300, each having a tip structure, and the insulating layer 1120, and the insulating layer 1120 is arranged beneath the gate electrode 1130. A doped region 1110 is formed by counter-doping dopants of a conductivity type different from the p-type, that is, n-type dopants into an upper portion of the p-type silicon substrate 1010. Formation of the doped region 1110 enables a higher current than in a non-doped element.

In addition, an isolation region 1200 or 1200b, formed beneath the insulating layer 1120, and the gate electrode 1130, formed beneath the insulating layer 1120, may block movement of electrons along the horizontal direction, thereby preventing a current concentration phenomenon in some of the plurality of probes 1300. In this regard, a layer of the isolation region can be formed by various methods. Doping with a high concentration of p-type dopants may increase the threshold voltage in such a manner as to reach or exceed a gate voltage. In addition, the isolation region with a trench structure may be formed, thereby physically preventing the movement of electrons.

With reference to FIGS. 3 and 4, an isolation region 1200 may be formed by heavily doping. Upon application of a positive voltage to the gate electrode 1130, electrons are induced in the depletion region. The electrons induced in the depletion region move through the n-type doped region 1110 beneath the gate electrode 1130 to the adjacent probes 1130, each having a tip structure, thereby generating an emission current.

When tunneling currents vary significantly through the probes 1130, each having a tip structure, electrons may also be supplied from an n- region somewhat spaced apart from an adjacent n- region, thereby causing a substantial increase in the current of a specific tip. Accordingly, there remains the possibility of arcing. To prevent this concentration of current, it is necessary to isolate an n layer as a specific region, thereby preventing the electrons from flowing into regions other than the adjacent n- region. In this regard, as a method of isolating the n layer as a specific region, a junction isolation structure in which a p layer is formed between n layers may be employed.

However, when a gate voltage is applied to the junction isolation structure, an n-type inversion layer is also formed at the interface between the p layer and the insulating layer 1120, thereby eliminating isolation. According to the present disclosure, a doped region 1200 having a high dopant concentration is formed in the p layer. Therefore, increasing the threshold voltage of a metal-oxide-semiconductor structure prevents formation of an n-channel, thereby forming the isolation structure.

In this regard, the isolation region 1200 of the p layer, having a high dopant concentration, is doped with the same p-type dopant as the silicon substrate 1010 and may be primarily doped with boron. A doping method, such as thermal diffusion or ion implantation, may be employed. The value of the dopant surface concentration Cs of the isolation region 1200 may be determined by taking the threshold voltage into consideration. In this regard, a concentration of 1E18 or more is required when a gate voltage ranges from 50 to 300 V. As the surface dopant concentration of boron increases in the doped region 1200, the threshold voltage increases. Taking into consideration a first thickness t1 of the doped region 1110 and the thickness of the silicon substrate 1010, a second thickness t2 of the isolation region 1200 having a high dopant concentration may be set to range from 1 nm to 10 μm. The number of the probes 1300 of silicon material, each having a tip structure, that are separated by the isolation regions 1200 may range from 1 to several hundred or more.

With reference to FIGS. 3 and 5, an isolation region 1200b may be formed to prevent additional inflow of electrons through the n layer. The isolation region 1200b may be formed as an insulating layer in a specific region of the doped region 1110, thereby electrically isolating the probes 1300 from each other. A method of forming the isolation region 1200b may include forming a trench structure by silicon etching and filling the trench structure with an insulating layer. The insulating layer with which the trench structure is filled may be formed of silicon oxide (SiO), silicon dioxide (SiO₂), silicon nitride (Si₃N₄), or aluminum oxide (Al₂O₃).

The isolation region 1200b, including the insulating layer with which the trench structure is filled, may be formed in such a manner that the second thickness t2 thereof is the same as or approximately equal to the second thickness t2 of the isolation region 1200 in FIG. 4. The isolation region 1200b is required to be formed in such a manner that the second thickness t2 thereof is greater than the thickness of at least the doped region 1110. The second thickness t2 of the isolation region 1200b may be set to range from 1 nm to 10 μm. The number of the probes 1300 of silicon material, each having a tip structure, that are separated by the isolation regions 1200b, each including the insulating layer with which the trench structure is filled, may range from 1 to several hundred or more.

With reference to FIGS. 3-5, the package 1000 including the field emission element may be configured to include the silicon substrate 1010, the doped region 1110, the insulating layer 1120, the isolation region 1200 or 1200b, and the plurality of probes 1300. The package 1000 may be configured to further include the gate electrode 1130 and the cathode electrode 1140.

The doped region 1110 may be arranged on one surface of the silicon substrate 1010. The cathode electrode 1140 may be arranged on the other surface of the silicon substrate 1010. The doped region 1110 may be arranged on the front surface of the silicon substrate 1010, and the cathode electrode 1140 may be arranged on the rear surface of the silicon substrate 1010. A voltage may be applied between the cathode electrode 1140 and the cathode electrode 1140.

The doped region 1110 may be formed on one surface of a silicon substrate 1010 in such a manner as to be doped with dopants. The plurality of probes 1300 may be formed in some regions of the doped region 1110 along one axial direction and another axial direction of the silicon substrate 1010. One axial direction and the other axial direction of the silicon substrate 1010 may correspond to the X-axis direction and the Y-axis direction, respectively.

The plurality of probes 1300 may be partitioned by the isolation region 1200 or 1200b, thereby forming a plurality of probe regions. The plurality of probe regions may include a first probe region 1300R1 and a second probe region adjacent to the first probe region 1300R1. At least one probe 1300 is arranged in the first probe region 1300R1 adjacent to one boundary of the isolation region 1200 or 1200b, in such a manner as to be spaced apart along the X-axis and Y-axis directions. At least one probe 1300 is arranged in the second probe region 1300R2 adjacent to the other boundary of the isolation region 1200 or 1200b, in such a manner as to be spaced apart along the X-axis and Y-axis directions.

The first probe region 1300R1 and second probe region 1300R2 may each be formed in a 1x1 array structure, a 2x2 array structure, a 3x3 array structure, a 4x4 array structure, a 5x5 array structure, or the like. The number of the probes 1300 arranged in the first probe region 1300R1 and the number of the probes 1300 arranged in the second probe region 1300R2 may be the same or different.

A first probe 1301 in the first probe region 1300R1 and a second probe 1302 in the second probe region 1300R2, adjacent to the first probe 1301 along the X-axis direction, are arranged to be spaced by a first distance dx1. The first probe 1301 in the first probe region 1300R1 and a third 1303 in the first probe region 1300R1, adjacent to the first probe 1301 along the X-axis direction are arranged to be spaced by a second distance dx2. The first distance dx1 may be set to be greater than the second distance dx2.

The insulating layer 1120 may be formed to surround the plurality of probes 1300 in the doped region 1110. The isolation region 1200 or 1200b may be formed to have a height in the Z-axis direction, which is a direction perpendicular to a portion of the doped region 1110 on top of the silicon substrate 1010, the portion corresponding to a region between the plurality of probes 1300. The gate electrode 1130 may be formed on the upper surface of the insulating layer 1010.

The isolation region 1200 or 1200b may be formed to prevent overcurrent from being concentrated on the probes 1300 due to movement of electrons along the horizontal direction of the silicon substrate 1010, or to prevent element destruction caused by the overcurrent. The horizontal direction of the silicon substrate 1010 may correspond to the X-axis direction or the Y-axis direction.

In order to increase the emission current, the doped region 1110 is formed, as a layer doped with dopants of a different conductivity type, on top of the p-type silicon substrate 1010. The doped region 1110 is formed beneath the plurality of probes 1300, each having a tip structure, the gate electrode 1130, and the insulating layer 1120. The doped region 1110, having a different conductivity type, can be formed on the silicon substrate 1010. The plurality of probes 1300, each having a tip structure, may be formed to have a different conductivity type than the doped region 1110.

In order to prevent element destruction due to overcurrent, the doped region 1110 may be formed beneath one portion of the gate electrode 1130 and the insulating layer 1120 in such a manner as to have the same conductivity type as the silicon substrate 1010 and to have a higher dopant concentration than the silicon substrate 1010.

The isolation region 1200 or 1200b may be formed in a grid structure extending along one axial direction and the other axial direction of the silicon substrate 1010. The grid structure of the isolation region 1200 or 1200b may be formed to partition the doped region 1110 in which the probes 1300 are formed. The isolation region 1200 or 1200b may be formed to extend into the doped region 1110 and the silicon substrate 1010 in a depth direction (the thickness direction or the Z-axis direction) of the package 1000.

The doped region 1110 may be formed on the upper surface of the silicon substrate 1010 in such a manner as to have a first thickness t1. The isolation region 1200 or 1200b may be formed to extend into the doped region 1110 in such a manner as to have a second thickness t2 greater than the first thickness t1.

The isolation region 1200 or 1200b may be formed by filling a trench structure, extending into the doped region 1100 to have the second thickness t2 greater than the first thickness t1, with an insulator. The doped region 1110 may be formed to be doped with dopants of a conductivity type different from that of the silicon substrate 1010. The isolation region 1200 or 1200b may be formed to be doped with dopants of the same conductivity type as the silicon substrate 1010 or with dopants of a conductivity type different from that of the silicon substrate 1010.

The silicon substrate 1010 may be formed as a p-type silicon substrate doped with p-type dopants at a first dopant concentration. The doped region 1110 may be formed as an n-type doped region doped with n-type dopants at a second dopant concentration. The isolation region 1200 or 1200b may be formed to be doped with p-type or n-type dopants at a third dopant concentration. The isolation region 1200 or 1200b may be formed at the third dopant concentration of p-type or n-type dopants, which is higher than the second dopant concentration of n-type dopants in the doped region 1110.

An ion implantation process may be performed to form the isolation region 1200 or 1200b, which is more heavily doped than the doped region 1110. The isolation region 1200 or 1200b may be doped with B, Al, or Ga. In this case, the energy used for ion implantation may range from 1 keV to 1 MeV, and the implantation depth may range from 10 nm to 10 µm.

Application of a gate voltage to the gate electrode 1130 should not result in formation of an inversion layer in the heavily doped isolation region 1200 or 1200b. Accordingly, the isolation region 1200 or 1200b may be heavily doped to a surface dopant concentration of at least 1E18/cm³. One or more probes 1300, each including a silicon tip structure, may be formed, the probes being partitioned by the heavily doped isolation region 1200 or 1200b. The probes 1300, each having a silicon tip structure, may correspond in number to the total number of silicon tips in an active region.

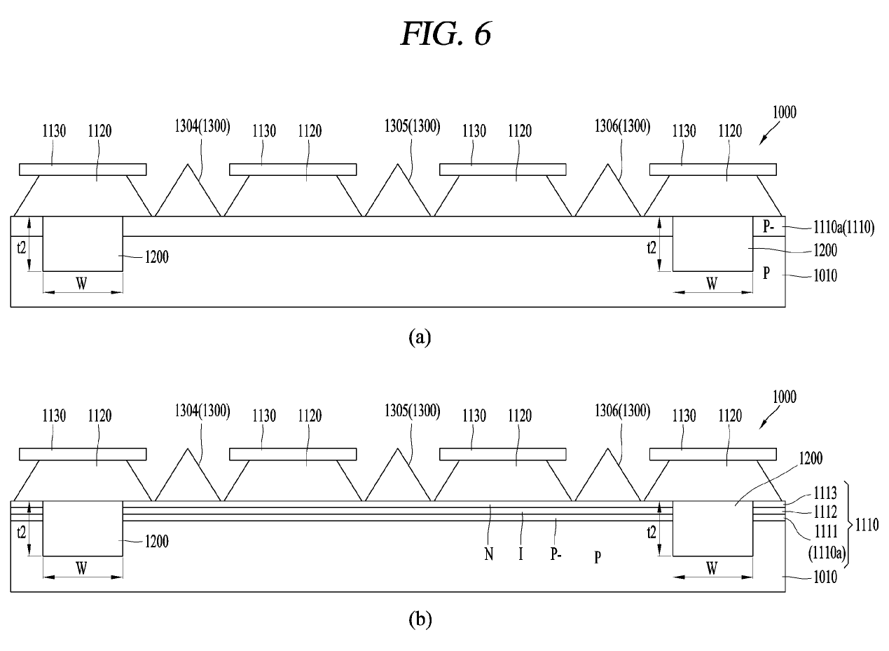

In addition, in the package 1000 including the field emission element according to an embodiment of the present disclosure, the doped region 1110 may be formed as at least one layer in the Z-axis direction. In this regard, FIG. 6 includes cross-sectional views illustrating the package 1000 that includes the doped region formed as at least one layer according to embodiments of the present disclosure. (a) of FIG. 6 is a cross-sectional view illustrating the package 1000 having a doped region formed as a p layer. (b) of FIG. 6 is a cross-sectional view illustrating the package 1000 having a doped region formed to include a p- layer, an i layer, and an n layer.

FIGS. 3 and (a) of 6 illustrate a doping profile of an element completed after performing counter-doping over the p-type silicon substrate 1010. In this regard, a doping gradient is present within the plurality of probes 1300, each having a silicon tip structure. The upper portion of the tip of each of the plurality of probes 1300 has an n-type dopant concentration equal to or higher than that of the lower portion thereof.

A p layer 1110a is present in the doped region 1110 beneath the insulating layer 1120, on top of which the gate electrode 1130 is formed. The p layer 1110a defines a p- region doped with p-type dopants at a dopant concentration relatively lower than a base dopant concentration (p-type dopants in the case of the p-type silicon substrate 1010). In this regard, p and p- are conceptual indicators associated with a relative dopant concentration and may vary depending on the dopant concentration of the silicon substrate 1010 itself.

The doped region 1110 may be formed as a p- layer 1110a doped with p-type dopants at a dopant concentration lower than that of the p-type silicon substrate 1010. Therefore, the doped region 1110 may be formed as a p-type region. The probes 1300 may be formed in such a manner that an n-type dopant concentration of each of the upper regions thereof is higher than that of each of the lower regions thereof.

FIGS. 3 and (b) of 6 illustrate a doping profile of an element completed after performing counter-doping on the p-type silicon substrate 1010. In this regard, a doping gradient is present within the plurality of probes 1300, each having a silicon tip structure. The upper portion of the tip of each of the plurality of probes 1300 has an n-type dopant concentration equal to or higher than that of the lower portion thereof.

The p- layer 1110a is present in the doped region 1110 beneath the insulating layer 1120, on top of which the gate electrode 1130 is formed. The p- layer 1110a defines a p- region doped with p-type dopants at a dopant concentration relatively lower than the base dopant concentration (p-type dopants in the case of the p-type silicon substrate 1010). In this regard, p and p- are conceptual indicators associated with a relative dopant concentration and may vary depending on the dopant concentration of the silicon substrate 1010 itself.

The p- layer 1110a may be referred to as a first semiconductor layer 1111. A second semiconductor layer 1112 is arranged above the first semiconductor layer 1111. The second semiconductor layer 1112, also referred to as the intrinsic semiconductor layer, defines the I region in which n-type dopant concentration and p-type dopant concentration are substantially equal, thereby exhibiting characteristics similar to those of intrinsic Si. A third semiconductor layer 1113 is arranged above the second semiconductor layer. The third semiconductor layer 1113 defines a p-type region in which a p-type dopant concentration is lower than the base dopant concentration as a result of compensation by n-type dopants. In this regard, n, i, and p- are conceptual indicators associated with a relative dopant concentration and may vary depending on the dopant concentration of the silicon substrate 1010 itself.

As described above, the doped region 1110 may include the first semiconductor layer 1111, the intrinsic semiconductor layer 1112, and the third semiconductor layer 1113. The first semiconductor layer 1111, the intrinsic semiconductor layer 1112, and the third semiconductor layer 1113 may correspond to the p- layer, the i layer, and the n layer, respectively.

The first semiconductor layer 1111 may be arranged on top of the silicon substrate 1010. The first semiconductor layer 1111 may be formed to be doped with p-type dopants at a fourth dopant concentration lower than the first dopant concentration of the silicon substrate 1010. The intrinsic semiconductor layer 1112 may be arranged on top of the first semiconductor layer 1111. The intrinsic semiconductor layer 1112 may be arranged between the first semiconductor layer 1111 and the third semiconductor layer 1113. The third semiconductor layer 1113 may be arranged on top of the intrinsic semiconductor layer 1112.

The third semiconductor layer 1113 may be formed to be doped with n-type dopants at the second dopant concentration. The third semiconductor layer 1113 may be formed to have the second dopant concentration higher than the first dopant concentration of the silicon substrate 1010. The probes 1300 may be formed in such a manner that an n-type dopant concentration of each of the upper regions thereof is higher than that of each of the lower regions thereof.

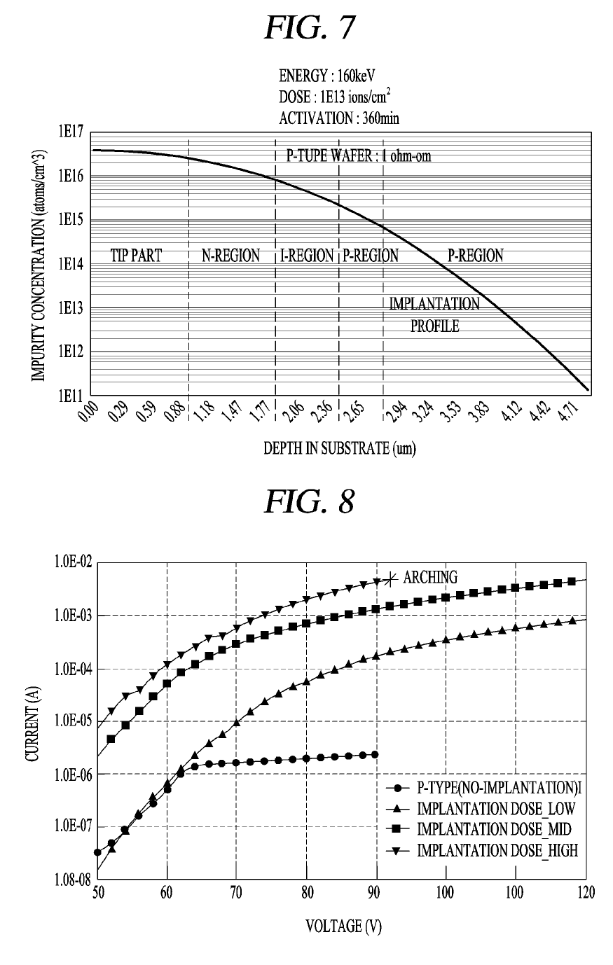

FIG. 7 is a graph illustrating doping profile simulation results for the package 1000 in which an n/i/p- layer structure is formed through ion implantation according to the present disclosure. With reference to FIGS. 3-7, the doping profile simulation results for the package 1000 are described. For example, the resistivity of the p-type silicon substrate 1010 may be 1 ohm^{-cm}, and the ion implantation conditions may include an energy of 160 keV, a dose of 1x10¹³ ions/cm², and activation at 1100° C. for 360 minutes. When silicon etching is performed to form the tip after ion implantation, the dopant concentration of the silicon substrate decreases by the height of the tip, and the dopant concentration of the tip portion increases significantly.

The p-type silicon substrate 1010 may have an impurity concentration of 5E15 ions/cm³. A portion in which the concentration of n-type dopants is higher than this may be referred to as an n region. A portion in which the concentrations of p-type and n-type dopants are substantially equal may be referred to as an i (intrinsic) region. A portion in which the concentration of p-type dopants is higher may be referred to as a p- or p region. The division of regions according to dopant concentration is relative and is not based on an absolute standard.

The depth and concentration of each region may be varied by adjusting the ion implantation conditions. When the dose is reduced to approximately 1x10¹³ ions /cm² or less, a doping profile configured as the P- or P region without the N region may be obtained.

The doped region 1110 may be formed through ion implantation and annealing processes. When the annealing process is performed after the ion implantation process, the dopant concentration tends to be reduced relative to the value of the dopant surface concentration Cs of the silicon surface with increasing implantation depth. A desired layer, such as an n-, i-, or player, may be formed under appropriate ion implantation conditions. The ion implantation conditions may be set variably depending on the doping profile. During n-type counter-doping, an implantation dose may range from 1x10¹¹ to 1x10¹⁴ ions/cm².

In evaluating and measuring the formation of the doping profile, analysis may be difficult at low dopant concentrations. The formation of the doping profile may be determined by C-V curve evaluation to check whether the n layer has been formed. In the case where the n layer is not formed, the p-type silicon substrate 1010 exhibits a C-V curve similar to that of a p-type substrate. Conversely, in a case where the n layer is not formed, the p-type silicon substrate 1010 exhibits a C-V curve similar to that of an n-type wafer.

In this regard, FIG. 8 illustrates emission current-voltage characteristics according to the implantation dose during ion implantation that uses n-type dopants. With reference to FIG. 8, the emission current increases as the implantation dose increases. In a case where the implantation dose is at an intermediate level, the emission current may increase by approximately 1,000 times compared to that of the p-type. In a case where the implantation dose is at a high level, the emission current may become unstable, and arcing may occur frequently. Therefore, optimization of the implantation dose, the energy, the activation, and the like is necessary to achieve high emission current while preventing arcing. In this regard, in a case where an n-i-p layer is formed using an epitaxial growth method, individual layers may be adjusted more freely.

The doped region 1110 may be formed by epitaxial growth. The n-i-p structure formed by the ion implantation process is defined by a doping gradient, and thus the dopant concentration and depth of each layer cannot be freely adjusted. For example, in order to increase the number of electron-hole pairs, the thickness of the i layer may be increased; however, such an increase is limited.

The use of an epitaxial method to grow silicon on the substrate has the advantage of independently adjusting the thickness and dopant concentration of each layer. For example, the thickness and dopant concentration of each layer may be adjusted by sequentially growing the p- layer, the i layer, and the n layer on the p-type silicon substrate 1010. Subsequently, the probes 1300, each having a tip structure, may be etched, and a silicon emitter structure may be formed. Etching the probes 1300, each having a tip structure, and forming the silicon emitter structure may be performed in a manner similar to ion implantation.

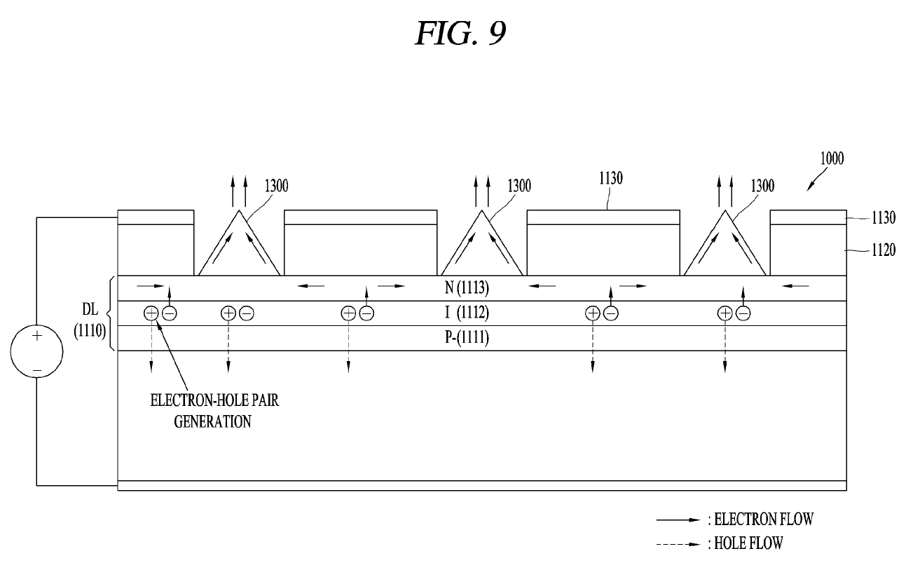

Regarding the package 1000 including an electron emission element according to embodiments of the present disclosure, the principle of electron emission in a p-/i/n layer structure is described. In this regard, FIG. 9 is a cross-sectional view illustrating the package 1000 that includes the field emission element having the p-/i/n layer structure.

With reference to (b) of FIGS. 6-9, since an electric field is applied in the reverse direction, the reverse current is significantly lower than the forward current. The reverse current primarily flows as a result of electron-hole pairs generated in the depletion layer DL. The depletion layer DL is formed at the interfaces between the i layer and the n layer and between the i layer and the p- layer and increases with increasing reverse voltage. Electrons generated in the depletion layer DL flow into the n layer, and holes flow into the silicon substrate 1010. The electrons flow into the n layer and then flow in the direction in which the probes 1300 are formed. Electrons are emitted in a vacuum by the strong electric field formed between the gate electrode and the probes 1300.

Therefore, the current is limited by electron-hole pairs generated in the depletion layer DL, by the resistance associated with the flow of electrons from the n layer to the probes 1300, each having a tip structure, and by electron emission due to tunneling in the probes 1300. The tunneling current is highly sensitive to the size, degree of contamination, and similar characteristics of the probes 1300, whereas the generation of electron-hole pairs and the resistance in the n layer substantially remain constant. In this regard, the current may remain uniform without concentrating on a specific probe 1300, thereby preventing arcing caused by current concentration on the specific probe 1300.

In a structure in (a) of FIG. 6, in which the p-/p layers are formed without the n layer and the i layer, the flow of current in the horizontal direction is limited due to the absence of the n layer. However, when a high voltage is applied to the gate electrode 1130, an inversion layer corresponding to the n layer is formed at the interface between the gate electrode 1130 and the insulating layer 1120, thereby allowing partial current flow.

With reference to FIGS. 3-8, the package 1000 including the field emission element is described in detail. At least one probe is arranged in the first probe region 1300R1 adjacent to one boundary of the isolation region 1200 or 1200b, in such a manner as to be spaced apart along the X-axis and Y-axis directions. At least one probe 1300 is arranged in the second probe region 1300R2 adjacent to the other boundary of the isolation region 1200 or 1200b, in such a manner as to be spaced apart along the X-axis and Y-axis directions. For example, a fourth probe 1304, a fifth probe 1305, and a sixth probe 1306 may be arranged spaced apart in the X-axis direction in the first probe region 1300R1.

The first probe region 1300R1 and second probe region 1300R2 may each be formed in a 1x1 array structure, a 2x2 array structure, a 3x3 array structure, a 4x4 array structure, a 5x5 array structure, or the like. The number of the probes 1300 arranged in the first probe region 1300R1 and the number of the probes 1300 arranged in the second probe region 1300R2 may be the same or different.

The first probe 1301 in the first probe region 1300R1 and the second probe 1302 in the second probe region 1300R2, adjacent to the first probe 1301 along the X-axis direction, are arranged to be spaced by the first gap dx1. The first probe 1301 in the first probe region 1300R1 and the third 1303 in the first probe region 1300R1, adjacent to the first probe 1301 along the X-axis direction are arranged to be spaced by the second gap dx2. The fourth probe 1304, the fifth probe 1305, and the sixth probe 1306, which are adjacent to one another in the X-axis direction of the first probe region 1300R1, are arranged to be spaced apart from one another by the second distance dx2. The first distance dx1 may be set to be greater than the second distance dx2.

The isolation region 1200 or 1200b may be formed in such a manner that the width W thereof ranges from 1 μm to 1 mm. The isolation region 1200 or 1200b may be formed in such a manner that the second thickness t2 thereof ranges 1 nm to 100 μm. The isolation region 1200 or 1200b may be formed in such a manner that the width thereof has a value greater than the second thickness thereof. For example, the isolation region 1200 or 1200b may be formed in such a manner that the width W thereof is 10 times to 1000 times greater than the second thickness t2 thereof.

The package 1000 including the electron emission element according to embodiments of the present disclosure may be formed in such a manner that the isolation region thereof is smaller or greater than the distance between adjacent probes 1300. The probes 1300 may be arranged along one axial direction and another axial direction in the first probe region 1300R1 adjacent to one boundary of the isolation region 1200 or 1200b. The probes 1300 may be arranged along one axial direction and the other axial direction in the second probe region 1300R2 adjacent to the other boundary of the isolation region 1200 or 1200b.

In this regard, the isolation region 1200 or 1200b may be formed in such a manner that the width W thereof is smaller than the first and second distances dx and dy between adjacent probes 1300 among the probes 1300. The first probe 1301 and the second probe 1302 may be arranged adjacent to one side of the isolation region 1200 or 1200b. The first distance dx1 between the first probe 1301 and the second probe 1302 may be maintained to be equal to or substantially equal to the second distance dx2 between the first probe 1301 and the third probe 1303 adjacent to the first probe 1301.

The first distance dx1 between the first probe 1301 and the second probe 1302 may be maintained to be equal to the second distance dx2 between the first probe 1301 and the third probe 1303 adjacent to the first probe 1301, thereby maintaining distances between the probes 1300 uniform across the entire region. The isolation region 1200 or 1200b may be formed in such a manner that the width W thereof is smaller than the distance dx or dy between adjacent probes 1300, but the occurrence of overcurrent between the probe regions can be effectively prevented. To this end, by optimizing the second thickness t2 of the isolation region 1200 or 1200b, the occurrence of overcurrent between the probe regions can be effectively prevented.

As another example, the isolation region 1200 or 1200b may be formed in such a manner that the width W thereof is greater than the distance dx or dy between adjacent probes 1300 among the probes 1300. The isolation region 1200 or 1200b may be formed in such a manner that the width W thereof is greater than the distance dx or dy between adjacent probes 1300, thereby effectively preventing the occurrence of overcurrent between the probe regions. Accordingly, the first probe 1301 in the first probe region 1300R1 and the second probe 1302 are formed in such a manner that the first distance dx1 therebetween is greater than the second distance dx2 between the first probe 1301 and the third probe 1303 in the first probe region 1300R1.

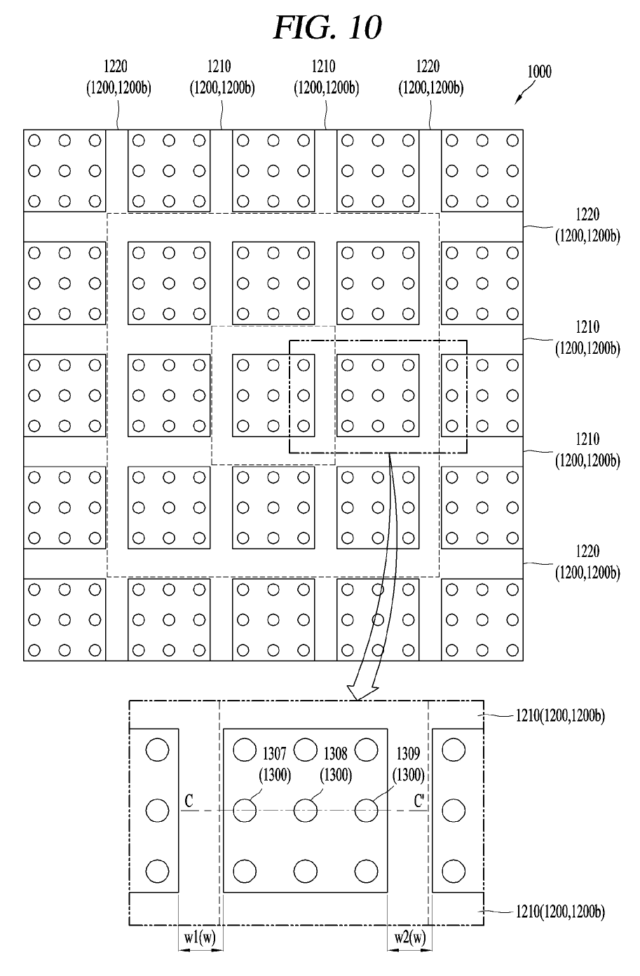

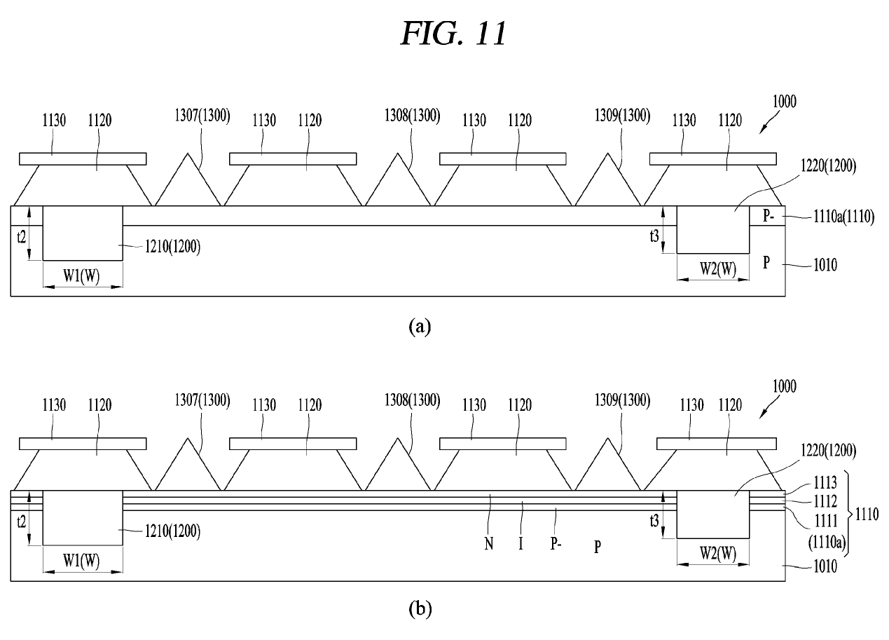

In the package 1000 including the electron emission element according to embodiments of the present disclosure, the isolation region 1200 or 1200b may be configured to have different dimensions depending on the arrangement of the probe regions. In this regard, FIG. 10 is a front view illustrating the package 1000 including a first isolation region and a second isolation region, according to the present disclosure. FIG. 11 includes cross-sectional views illustrating the package 1000 in FIG. 9, which includes either the p- layer alone, or the p- layer, the i layer, and the n layer, according to embodiments of the present disclosure.

(a) of FIG. 11 is a cross-sectional view illustrating the package 1000 of FIG. 9, which includes the p- layer in (a) of FIGS. 6(b) of 11 is a cross-sectional view illustrating the package 1000 of FIG. 9, which includes the p- layer, the i layer, and the n layer in (b) of FIG. 6. A cross-sectional structure in FIG. 11 corresponds to the cross-section taken along line CC’ in FIG. 10.

With reference to FIGS. 10 and 11, a seventh probe 1307, an eighth probe 1308, and a ninth probe 1309 may be arranged to be spaced apart from one another along line CC’. A first isolation region 1210 may be formed beneath the insulating layer 1120 on one side of the seventh probe 1307. A second isolation region 1220 may be formed beneath the insulating layer 1120 on the other side of the ninth probe 1309.

With reference to FIGS. 4-11, the isolation region 1200 may be configured to include the first isolation region 1210 and the second isolation region 1220. The first isolation region 1210 may be formed in the central region of the silicon substrate 1010. The second isolation region 1220 may be formed in the surrounding region of the silicon substrate 1010. For example, in the package 1000 having a 5x5 array structure, a 3x3 array structure may correspond to the central region of the silicon substrate 1010. A region surrounding the 3x3 array structure may correspond to the surrounding region of a silicon substrate 1010.

The first isolation region 1210 may be formed in such a manner that a first width W1 thereof is different from a second width W2 of the second isolation region 1220. The first isolation region 1210 may be formed in such a manner that the first width W1 thereof is greater than the second width W2 of the second isolation region 1220. In this regard, the distance between the probes 1300 is smaller in the surrounding region of the package 1000 than in the central region thereof, or the number of the probes 1300 is greater in the surrounding region than in the central region, thereby increasing the density of the probes 1300. Therefore, the first isolation region 1210 is formed in such a manner that the first width W1 thereof is greater than the second width W2 of the second isolation region 1220, thereby effectively preventing the occurrence of overcurrent in each probe region.

The first isolation region 1210 may be formed in such a manner that the second thickness t2 is different from a third thickness t3 of the second isolation region 1220. The first isolation region 1210 may be formed in such a manner that the second thickness t2 is greater than the third thickness t3 of the second isolation region 1220. In this regard, the distance between the probes 1300 is smaller in the surrounding region of the package 1000 than in the central region thereof, or the number of the probes 1300 is greater in the surrounding region than in the central region, thereby increasing the density of the probes 1300. Therefore, the first isolation region 1210 is formed in such a manner that the second thickness t2 thereof is greater than the third thickness t3 of the second isolation region 1220, thereby effectively preventing the occurrence of overcurrent in each probe region.

The first isolation region 1210 may be formed in such a manner that a first dopant concentration thereof is different from a second dopant concentration of the second isolation region 1220. The first isolation region 1210 may be formed in such a manner that the first dopant concentration thereof is higher than the second dopant concentration of the second isolation region 1220. In this regard, the distance between the probes 1300 is smaller in the surrounding region of the package 1000 than in the central region thereof, or the number of the probes 1300 is greater in the surrounding region than in the central region, thereby increasing the density of the probes 1300. Therefore, the first isolation region 1210 is formed in such a manner that the first dopant concentration is higher than the second dopant concentration of the second isolation region 1220, thereby effectively preventing the occurrence of overcurrent.

The probes 1300 may be arranged along one axial direction and another axial direction in the first probe region 1300R1 adjacent to one boundary of the isolation region 1200 or 1200b. The probes 1300 may be arranged along one axial direction and the other axial direction in the second probe region 1300R2 adjacent to the other boundary of the isolation region 1200 or 1200b.

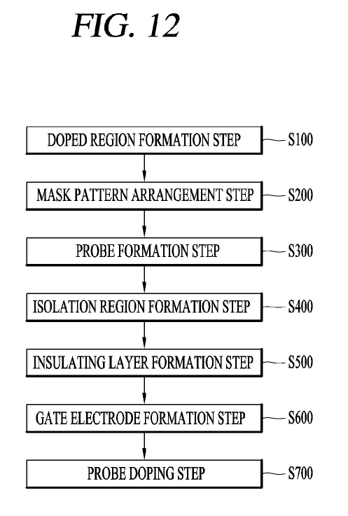

The package, including the field emission element, according to the present disclosure, may be manufactured by an apparatus for manufacturing the package. A method of manufacturing the package including the field emission element according to the present disclosure is described below. FIG. 12 is a flowchart illustrating the method of manufacturing the package that includes the field emission element according to the present disclosure. With reference to FIG. 12, the manufacturing method may include a doped region formation step S100, a mask pattern arrangement step S200, a probe formation step S300, and an isolation region formation step S400. The manufacturing method may further include an insulating layer formation step S500 and a gate electrode formation step S600.

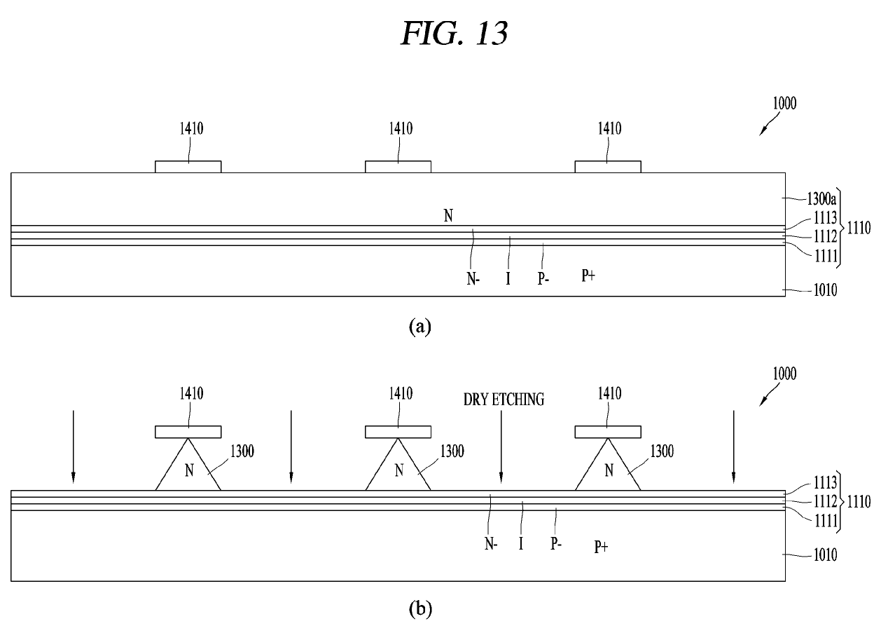

FIG. 13 includes cross-sectional views illustrating the package 1000 manufactured by performing steps in FIG. 12 of the manufacturing method. With reference to FIGS. 3 and (a) of 13, a doped region 1110b doped with dopants may be formed on one surface of the silicon substrate 1010 in the doped region formation step S100. The doped region 1110b may include the first semiconductor layer 1111, the intrinsic semiconductor layer 1112, and the third semiconductor layer 1113 that correspond to a p- layer, an i layer, and an n- layer, respectively. A probe region 1300a corresponding to an n layer, on top of which the probes 1300 are to be formed, may be arranged on top of a doped region 1110b. The doped region 1110b may include the first semiconductor layer 1111, the intrinsic semiconductor layer 1112, the third semiconductor layer 1113, and the probe region 1300a.

In the mask pattern arrangement step S200, mask patterns 1410 may be placed in the probe region 1300a. In the mask pattern arrangement step S200, the mask patterns 1410 may be arranged in portions, respectively, of the doped region 1110 in such a manner that the plurality of probes 1300 are formed in the portions, respectively, of the doped region 1110. In this regard, the doped region 1110 may be configured to include the probe region 1300a corresponding to the n layer, on top of which the probes 1300 is to be formed, the probe region 1300a constituting the upper portion of the doped region 1110.

With reference to FIGS. 3, 12, and (b) of 13, in the probe formation step S300, by etching the doped region 1110, the plurality of probes 1300 may be formed in one portion of the doped region 1110 along one axial direction and the other axial direction of the silicon substrate 1010.

With reference to FIGS. 3 and 13, all regions of the silicon substrate 1010 may be ready to be doped before the plurality of probes 1300, each having a tip structure, are formed. The probes 1300, each having a tip structure, may be formed in one portion of the doped region 1110 in which the mask pattern 1410 is arranged by silicon etching. The doped region 1110, including an n layer, an n- layer, an i layer, and a p layer, may be formed through ion implantation. The probes 1300, each having a tip structure, may be formed by performing a process of etching the silicon substrate 1010 using the mask pattern 1410.

In the isolation region formation step S400, the isolation region 1200 or 1200b may be formed in a portion of the doped region 1110 on top of the silicon substrate 1010, the portion corresponding to a region among the plurality of probes 1300 and a portion of the silicon substrate 1010. In the insulating layer formation step S500, the insulating layer 1120 may be formed among the plurality of probes 1300 to surround the plurality of probes 1300. In the gate electrode formation step S600, the gate electrode 1130 may be formed on the upper surface of the insulating layer 1120.

In the doped region formation step S100, the doped region 1110 may be formed to have the first thickness t1 on the upper surface of the silicon substrate 1010. In the isolation region formation step S400, the isolation region 1200 or 1200b may be formed to extend into the doped region 1110 and the silicon substrate 1010 at the second thickness t2 greater than the first thickness t1 in the depth direction of the package 1000.

In the doped region formation step S100, the doped region 1110 may be formed to be doped with dopants that are a type different from that of the silicon substrate 1010. The isolation region formation step S400 may include a trench structure formation step S410 and an insulator formation step S420. In the trench structure formation step S410, the isolation region 1200i or 1200b may form a trench structure, having the second thickness t2 greater than the first thickness t1, within the doped region 1110. In the insulator formation step S420, an insulator may be formed by filling the trench structure, having the second thickness t2, with an insulating material.

As described above, the silicon substrate 1010 may be configured as a p-type silicon substrate 1010 doped with p-type dopants at the first dopant concentration. In the doped region formation step S100, the doped region 1110 may be configured as an n-type doped region doped with n-type dopants at the second dopant concentration. In the isolation region formation step S400, the isolation region 1200 or isolation region 1200b may be formed to be doped with p-type or n-type dopants at the third dopant concentration. The isolation region 1200 or 1200b may be formed to be doped with p-type or n-type dopants at the third dopant concentration higher than the second dopant concentration at which the doped region 1110 is doped with n-type dopants. Therefore, the isolation region 1200 or 1200b may be doped at a higher dopant concentration than the doped region 1110.

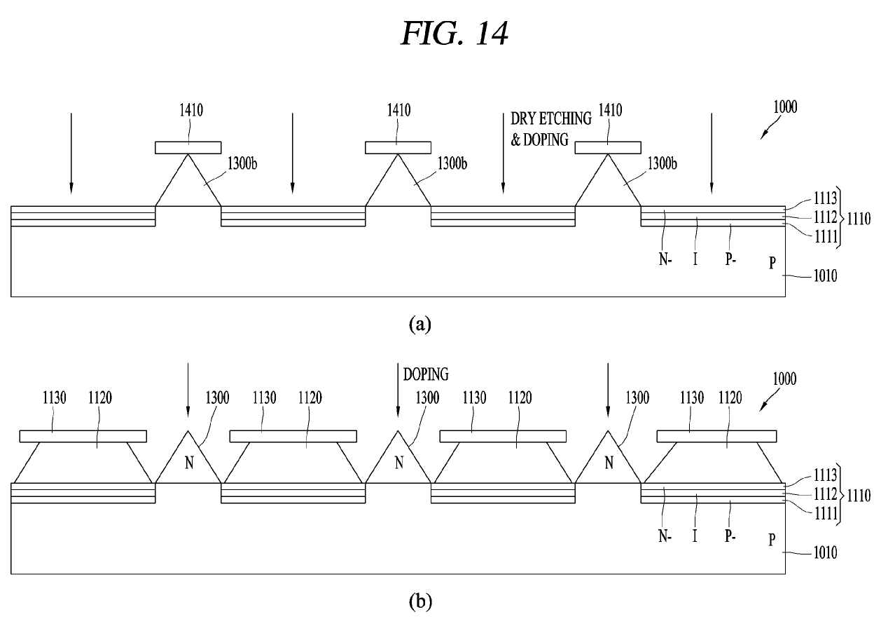

In the method of manufacturing the package 1000 including the field emission element according to an embodiment of the present disclosure, the plurality of probes 1300 may be doped with n-type dopants after being doped with p-type dopants. In this regard, FIG. 14 includes cross-sectional views illustrating the package 1000 that is manufactured by doping p-type probes with n-type dopants.

With reference to FIG. 13, when the probes 1300, each having a tip structure, are formed by performing an etching process, a uniform and reproducible doping profile may be difficult to obtain if the silicon etching depth is not constant. With reference to FIG. 14, after forming the probes 1300b, ion implantation is performed in a state where the mask pattern 1410, serving as an insulating layer, remains on the tip region of the probe 1300, and the probes 1300b are further doped by performing ion implantation, thereby forming n-type probes 1300.

With reference to (a) of FIG. 14, in the probe formation step S300, tip patterns of the probes 1300b may be formed by silicon etching. With reference to (b) FIG. 14, a desired layer may be formed by doping all regions of the silicon substrate 1010 through ion implantation. A doping process that uses ion implantation does not require silicon etching, thereby enabling doping with a lower dopant concentration than in the embodiment in FIG. 13. The exposed silicon in the tip portion may not be doped, thereby causing non-uniform current flow. Therefore, after fabricating the element, a probe doping step S700 may additionally be performed through ion implantation on the probes 1300a, each having a tip structure, thereby forming n-type probes 1300.

With reference to FIGS. 3 and 14, the method of manufacturing the package 1000 according to an embodiment of the present disclosure is described. The doped region 1110 formed during the doped region formation step S100 may include a first semiconductor layer 1111, which is the p- layer 1110a having a p-type dopant concentration lower than that of the silicon substrate 1010. In the probe formation step S300, the plurality of probes 1300 may be formed to have the same conductivity type as either the p- layer 1110a in the doped region 1110 or the silicon substrate 1010.

In addition, the manufacturing method may further include the probe doping step S700, which involves doping the plurality of probes with n-type dopants, after the gate electrode formation step S600. In this regard, the sequence of performing the probe doping step S700 is not limited to the order described above. For example, the probe doping process S700 may also be performed between the probe formation process S300 and the isolation region formation step S400. In the probe doping step S700, the probes 1300 may be formed in such a manner that an n-type dopant concentration of each of the upper regions thereof is higher than an n-type dopant concentration of an n layer region beneath the insulating layer 1120.

The doped region formation step S100 may include a first semiconductor layer formation step S110, an intrinsic semiconductor layer formation step S120, and a third semiconductor layer formation step S130. In the first semiconductor layer formation step S110, the first semiconductor layer 1111, which is doped with p-type dopants at the fourth dopant concentration lower than the first dopant concentration of the silicon substrate 1010, may be formed on top of the silicon substrate 1010. In the intrinsic semiconductor layer formation step S120, the intrinsic semiconductor layer 1112 may be formed on top of the first semiconductor layer 1111. In the 2-second semiconductor layer formation step S120, the 3-third semiconductor layer 1113, which is doped with n-type dopants at the second dopant concentration, may be formed on top of the intrinsic semiconductor layer 1112.

The third semiconductor layer 1113 may be formed to have the second dopant concentration higher than the first dopant concentration of the silicon substrate 1010. In the probe formation step S300, the probes 1300 may be formed in such a manner that an n-type dopant concentration of each of the upper regions thereof is higher than an n-type dopant concentration of each of the lower regions thereof.

In the isolation region formation step S400, the isolation region 1200 or 1200b may be formed in such a manner that the width W thereof ranges from 1 μm to 1 mm. In the isolation region formation step S400, the isolation region 1200 or 1200b may be formed in such a manner that the second thickness t2 ranges from 1 nm to 100 μm. The isolation region 1200 or 1200b may be formed to have a value greater than the second thickness t2 of the isolation region 1200 or 1200b.

In the isolation region formation step S400, the probes 1300 may be arranged along one axial direction and the other axial direction along the first probe region 1300R1 adjacent to one boundary of the isolation region 1200 or 1200b. In the isolation region formation step S400, the probes 1300 may be arranged along one axial direction and the other axial direction in the second probe region 1300R2 adjacent to the other boundary of the isolation region 1200 or 1200b. The isolation region 1200 or 1200b may be formed in such a manner that the width W thereof is greater than the distance between adjacent probes 1300. Alternatively, the isolation region 1200 or 1200b may be formed in such a manner that the width W thereof is equal to or smaller than the distance between adjacent probes 1300.

The isolation region formation step S400 may be configured to include a first isolation region formation step and a second isolation region formation step. In the first isolation region formation step, the first isolation region 1210 may be formed in the central region of the silicon substrate 1010. In the second isolation region formation step, the second isolation region 1220 may be formed in the surrounding region of the silicon substrate 1010. The first isolation region 1210 may be formed in such a manner that the first width W1 thereof is greater than the second width W2 of the second isolation region 1220. The first isolation region 1210 may be formed in such a manner that the second thickness t2 thereof is greater than the third thickness t3 of the second isolation region 1220.

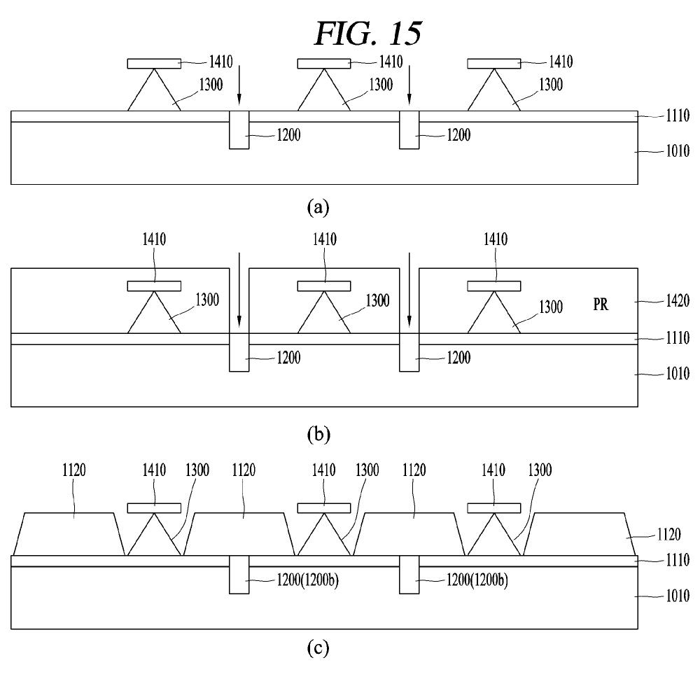

The isolation region formation step S400 of the method of manufacturing the package 1000 according to the present disclosure is described in detail. In this regard, FIG. 15 includes one cross-sectional view illustrating the package 1000 before the isolation region 1200 has been formed and two cross-sectional views illustrating the package 1000 after the isolation region 1200 has been formed.

With reference to FIGS. (a) of 15, the doped region 1110 may be formed on top of the silicon substrate 1010, and the probe tips 1300, each having a tip structure, may be formed in one portion of the doped region 1110. With reference to FIGS. 12 and (a) of 15, the mask pattern 1410 is arranged on top of each of the probes 1300 by performing an etching process.

With reference to FIGS. 12 and (b)15, the isolation region formation step S400 may be performed in a state where the mask pattern 1410 and a photoresist layer 1420 is formed in the region where the probes 1300 are formed. In the isolation region formation step S400, the isolation region 1200 or 1200b may be formed through ion implantation.

The isolation region 1200 or 1200b may be formed in a region between the probes 1300, each having a Si tip structure. The isolation region 1200 or 1200b is a region that is more heavily doped with dopants (e.g., boron) of the same type as those in the p-type silicon substrate 1010 than the doped region 1110. The ion implantation process is performed in a state where patterns of the photoresist layer 1420 are arranged in regions other than the region where the isolation region 1200 or 1200b is formed. The ion implantation process using a shadow mask that can serve as the mask pattern 1410 and the photoresist layer 1420 is also applicable.

With reference to FIGS. 12 and (c)15, the insulating layer formation step S500 may be performed to form the insulating layer 1120 corresponding to an oxidation or passivation region. Subsequent processing steps may correspond to steps in FIG. 12.

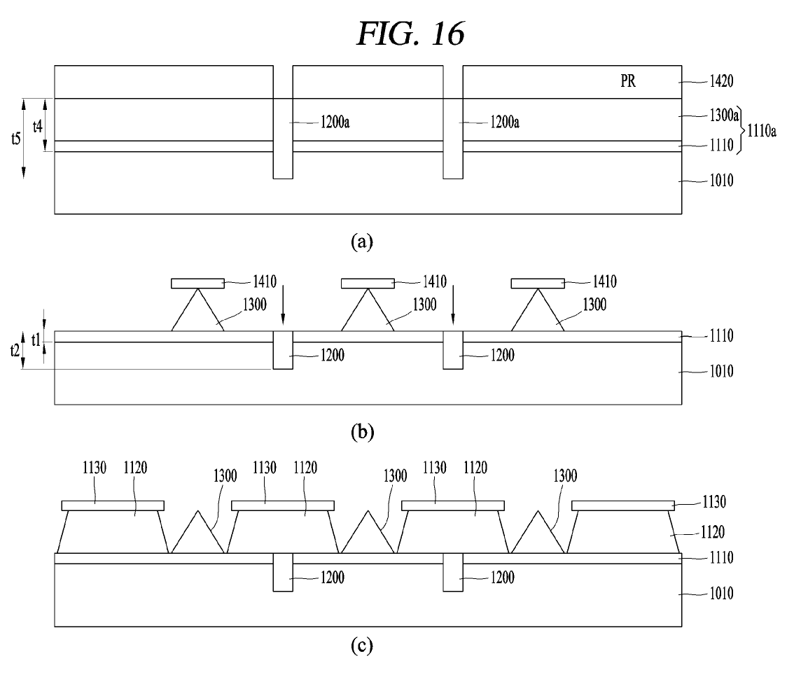

In the method of manufacturing the package 1000 according to an embodiment of the present disclosure, after the isolation region formation step S400 is performed, the probe region formation step S300 may be performed. In this regard, FIG. 16 illustrates one cross-sectional view illustrating the package 1000 after the isolation region 1200a has been formed and before the probe region 1300a is formed, and two cross-sectional views illustrating the package 1000 after the probe region 1300a has been formed.

With reference to (a) of FIG. 16, the doped region 1110a of a conductivity type different from that of the p-type silicon substrate 1010 may be formed through counter-doping. With reference to FIGS. 12 and (a)16, the isolation region formation step S400 may be performed after the mask pattern arrangement step S200. The isolation region 1200a, which extends through the doped region 1110a and the silicon substrate 1010, may be formed during the isolation region formation step S400. The doped region 1110a may include a probe region 1300a and the doped region 1110 formed as an n- layer.

In the mask pattern arrangement step S200, the photoresist layer 1420 may be arranged on top of the probe region 1300a. The photoresist layer 1420 may be replaced with a shadow mask, and the ion implantation process may be performed using the shadow mask. The isolation regions 1200 or 1200b may be formed through ion implantation in regions where the photoresist layer 1420 is arranged. The isolation region 1200a may be formed, through ion implantation, to have a fourth thickness. The isolation region 1200a may be formed to have a fifth thickness t5 greater than a fourth thickness t4 of the doped region 1110a on which counter-doping is performed. Accordingly, the mask pattern 1410 may be prevented from detaching from the top of each of the probes 1300 that are formed to have a tip structure by performing a PR process that uses the photoresist layer 1420.

With reference to FIGS. 12, (a)16, and (b)16, the isolation region formation step S400 may be performed, and the probe region formation step S300 may be performed. In the probe region formation step S300, the plurality of probes 1300, each having a tip structure, may be formed. The plurality of probes, each having a tip structure, may be formed through dry etching that uses the mask pattern 1410. During the probe region formation step S300, the isolation region 1200 may be formed to have the second thickness t2. During the probe region formation step S300, the doped region 1110 may be formed to have the first thickness t1 smaller than the second thickness t2.

In the probe region formation step S300, the doped region 1110a may be etched by performing an etching process in such a manner that the width thereof is greater than that of the isolation region 1200. Through the probe region formation step S300, the plurality of probes 1300 may be formed in portions of the doped region 1110 along one axial direction and the other axial direction of the silicon substrate 1010.

With reference to FIGS. 12, (b) of 16, and (c)16, after the probes 1300 are formed during the probe region formation step S300, the mask patterns 1410 may be removed. The insulating layer formation step S500 may be performed to form the insulating layer 1120 corresponding to the oxidation or passivation region, and the gate electrode formation step S600 may be performed. The above-described processing steps may correspond to the steps in FIG. 12.

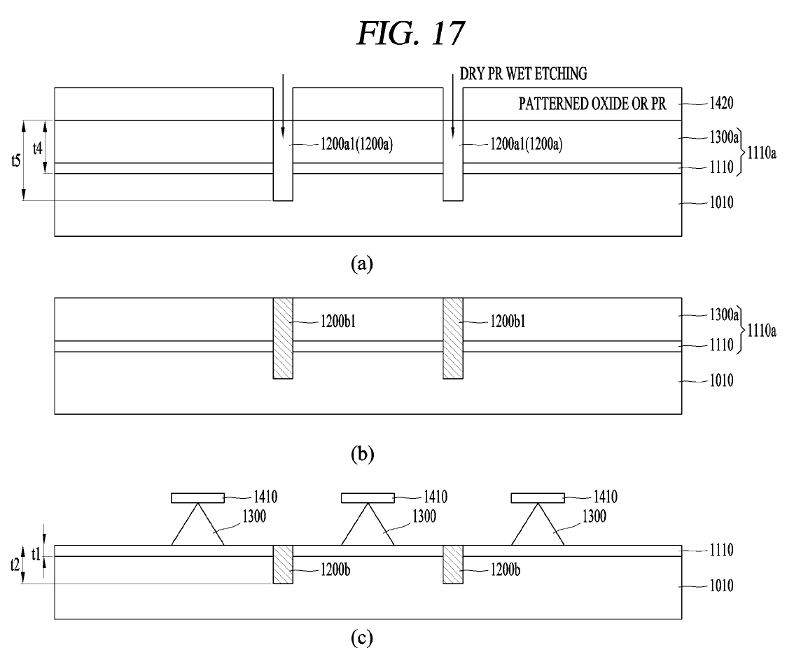

In the method of manufacturing the package 1000 having the field emission element according to embodiments of the present disclosure, the insulating layer 1120 may be formed within a trench structure. In this regard, FIG. 17 includes one cross-sectional view illustrating the package 1000 before the isolation region 1200 with the trench structure has been formed and before the probe region 1300a is formed and two cross-sectional views illustrating the package after the probe region 1300a has been formed.

With reference to (a) of FIG. 17, the n-type doped region 1110 different from the p-type silicon substrate 1010 may be formed through counter-doping. With reference to FIGS. 12 and (a)17, the isolation region formation step S400 may be performed after the mask pattern arrangement step S200. During the isolation region formation step S400, the trench structure formation step S410 may be performed. During the trench structure formation step S410, the isolation region 1200a, having a trench structure 1200a1 that extends through the n-type doped region 1110 and the p-type silicon substrate 1010, may be formed.

In the mask pattern arrangement step S200, the photoresist layer 1420 may be arranged on top of the doped region 1110a. The photoresist layer 1420 may be replaced with a patterned oxide layer, and the ion implantation process may be performed using the patterned oxide layer. The isolation region 1200a, having the trench structure 1200a1, may be formed through ion implantation in a region where the photoresist layer 1420 is not arranged. The isolation region 1200a, having the trench structure 1200a1, which is formed through ion implantation, may be formed to have the fourth thickness t4. The isolation region 1200a, having the trench structure 1200a1, may be formed to have a fifth thickness t5 greater than a fourth thickness t4 of the doped region 1110a on which counter-doping is performed.

Before forming the probes 1300, each having a tip structure, a dry or wet etching process may be performed to define the isolation region 1200ahaving the trench structure 1200a1. Various methods for improving the aspect ratio of width to thickness or width to length may be employed during the dry etching process. In this regard, the isolation region 1200a, having the trench structure 1200a1 formed using a laser source, may be formed.

With reference to FIGS. 12, (a) of 17, and (b) of 17, in the isolation region formation step S400, the insulator layer formation step S420 may be performed. In the insulator formation step S420, an insulator may be formed by filling the isolation region 1200aextending into the silicon substrate 1010, which has the trench structure 1200a1 with the fifth thickness t5, with an insulating material. The isolation region 1200amay be filled with an insulator to provide isolation between channels adjacent to the isolation region 1200ahaving the trench structure 1200a1. To form an insulating layer, the isolation region 1200ahaving the trench structure 1200a1 may be filled with an insulator, such as silicon oxide (SiO), silicon dioxide (SiO₂), silicon nitride (Si₃N₄), or aluminum oxide (Al₂O₃), thereby forming an isolation region 1200b1.

With reference to FIGS. 12, (b) of 17, and (c) of 17, the mask pattern 1410 may be deposited, and the plurality of probes 1300, each having a tip structure, may be formed by performing an etching process. The isolation region formation step S400 may be performed, and the probe region formation step S300 may be performed. In the probe region formation step S300, the plurality of probes 1300, each having a tip structure, may be formed. The plurality of probes, each having a tip structure, may be formed through dry etching that uses the mask pattern 1410. During the probe region formation step S300, the isolation region 1200b may be formed to have the second thickness t2. During the probe region formation step S300, the doped region 1110 may be formed to have the first thickness t1 smaller than the second thickness t2.

During the probe region formation step S300, the doped region 1110a may be etched by performing an etching process in such a manner that the width thereof is greater than that of the isolation region 1200b. Through the probe region formation step S300, the plurality of probes 1300 may be formed in portions of the doped region 1110 along one axial direction and the other axial direction of the silicon substrate 1010.

When the probes 1300 are formed during the probe region formation step S300, the mask pattern 1410 may be removed. The insulating layer formation step S500 may be performed to form the insulating layer 1120 corresponding to the oxidation or passivation region, and the gate electrode formation step S600 may be performed. The above-described processing steps may correspond to the steps in FIG. 12.

Various embodiments of the package 1000, including the field emission element, according to the present disclosure, and the method of manufacturing the package 1000 have been described above. With reference to FIGS. 3-17, the package 1000, including the field emission element, which is manufactured by the example of the manufacturing method according to the present disclosure, is described below.

A method of manufacturing the package 1000 including the field emission element may include the doped region formation step S100, the mask pattern arrangement step S200, the probe formation step S300, the isolation region formation step S400, the insulating layer formation step S500, and the gate electrode formation step S600. In this regard, after the mask pattern arrangement step S200, the isolation region formation step S400 may be performed, and then the probe formation step S300 may be performed.

In the doped region formation step S100, the package 1000 may include the doped region 1110 or 1110aformed on one surface of the silicon substrate 1010 in such a manner as to be doped with dopants. In the mask pattern arrangement step S1410, the mask patterns 1410 may be arranged in portions, respectively, of the doped region 1110 or 1110ain such a manner that the plurality of probes 1300 are formed in portions, respectively, of the doped region 1110, or 1110a.

In the probe formation step S300, the doped region 1110 or 1110a may be etched, and thus the package 1000 may include the plurality of probes 1300 formed in portions, respectively, of the doped region 1110 or 1110aalong one axial direction and the other axial direction of the silicon substrate 1010. In the isolation region formation step S400, the package 100 may include the doped region 1110 on top of the silicon substrate 1010. A portion of the doped region 1110 corresponds to a region between the plurality of probes 1300.

Because the isolation region formation step S400 is previously performed, the package 100 may include the doped region, corresponding to a region between the plurality of probes 1300, and the isolation region 1200a or 1200a1 formed in the silicon substrate 1010. In the probe formation step S300, the doped region 1110a is etched, and thus the package 1000 may include the plurality of probes 1300 formed in portions, respectively, of the doped region 1110 along one axial direction and the other axial direction of the silicon substrate 1010.

In the insulating layer formation step S500, the package 1000 may include the insulating layer 1120 formed in the doped region 1110 to surround the plurality of probes 1300. In the gate electrode formation step S600, the package 1000 may include the gate electrode 1130 formed on the upper surface of the insulating layer 1120.

The isolation region 1200 or 1200bmay be formed to prevent overcurrent from being concentrated on the probes 1300 due to the movement of electrons along the horizontal direction of the silicon substrate 1010, or to prevent element destruction caused by the overcurrent.

Examples of the package 1000 including the field emission element, the method of manufacturing the package 1000, and the package 1000 manufactured using the method have been described above. The technical effects of the package including the field emission element, the method of manufacturing the package, and the package manufactured using the method are described as follows.

According to the present disclosure, a package including a field emission element and a method of manufacturing the package can be provided.

According to the present disclosure, because emission current is concentrated on silicon tip-shaped probes, element destruction can be prevented.

According to the present disclosure, a doped region serving as a counter-doped layer can be arranged on top of a silicon substrate, thereby increasing the emission current of the field emission element even under low emission conditions.

According to the present disclosure, the doped region is formed on top of the silicon substrate, and an isolation region formed in a portion of the doped region can extend to a predetermined depth into the silicon substrate, thereby structurally preventing the emission current from being concentrated on probes.

According to the present disclosure, by optimally forming the doped region and the isolation region, a short circuit from a gate electrode to a cathode electrode and thermal breakdown can be prevented.

The further scope of applicability of the present disclosure will become apparent from the detailed description set forth above. Furthermore, it will be apparent to those skilled in the art that various modifications and variations may be made within the spirit and scope of the present disclosure. Accordingly, the detailed description and specific embodiments, including the preferred embodiment, are provided as illustrative examples only.

What is claimed is:

1. A package including a field emission element, the package comprising:
a silicon substrate;
a doped region formed on one surface of the silicon substrate and doped with dopants;
a plurality of probes formed at the doped region and grouped in regions along a first axial direction and a second axial direction of the silicon substrate;
an insulating layer formed at the doped region and surrounding the plurality of probes;
a gate electrode formed at an upper surface of the insulating layer; and
an isolation region formed in the doped region in a depth direction of the doped region and configured to prevent overcurrent from being concentrated on the probes due to movement of electrons along horizontal directions of the silicon substrate and to prevent element destruction caused by the overcurrent.

2. The package of claim 1, wherein the isolation region is formed between regions of probes in a grid structure extending along the first axial direction and the second axial direction of the silicon substrate.

3. The package of claim 1, wherein the isolation region is formed to extend in the depth direction into the doped region and the silicon substrate.

4. The package of claim 3, wherein the doped region is formed on an upper surface of the silicon substrate to have a first thickness, and
wherein the isolation region is formed to extend in the depth direction into the doped region to have a second thickness greater than the first thickness.

5. The package of claim 4, wherein the silicon substrate is formed as a p-type silicon substrate doped with p-type dopants at a first dopant concentration,
wherein the doped region is formed as an n-type doped region doped with n-type dopants at a second dopant concentration,
wherein the isolation region is doped with p-type dopants at a third dopant concentration, and
wherein the third dopant concentration is higher than the second dopant concentration.

6. The package of claim 4, wherein the isolation region is formed as a filled trench extending into the doped region to have the second thickness, and
wherein the doped region is doped with dopants of a conductivity type different from that of the silicon substrate.

7. The package of claim 1, wherein the doped region is formed to have a p-type dopant concentration lower than that of the silicon substrate, and
wherein each of the plurality of probes are formed in such a manner that an n-type dopant concentration of an upper region of a probe thereof is higher than that of a lower region of the probe.

8. The package of claim 1, wherein the doped region comprises:
a first semiconductor layer formed on top of the silicon substrate and doped with p-type dopants at a fourth dopant concentration lower than a first dopant concentration of the silicon substrate;
an intrinsic semiconductor layer formed on top of the first semiconductor layer; and
a third semiconductor layer formed on top of the intrinsic semiconductor layer and doped with n-type dopants at a second dopant concentration, and
wherein the second dopant concentration is higher than the first dopant concentration.

9. The package of claim 8,
wherein each of the plurality of probes are formed in such a manner that an n-type dopant concentration of an upper region of a probe is higher than that of a lower region of the probe.

10. The package of claim 1, wherein the isolation region is formed to have a width in a range from 1 μm to 1 mm,
wherein the isolation region is formed to have a second thickness in a range from 1 nm to 100 μm, and
wherein the width of the isolation region is greater than the second thickness of the isolation region.

11. The package of claim 1, wherein the plurality of probes comprises a first probe region adjacent to one boundary of the isolation region and a second probe region adjacent to an other boundary of the isolation region opposite the one boundary, and
wherein a width of the isolation region is less than a distance between adjacent probes in the first and second probe regions.

12. The package of claim 1, wherein the isolation region includes a first isolation region formed at a central region of the silicon substrate and a second isolation region formed at a surrounding region of the silicon substrate,
wherein the first isolation region is formed to have a first width greater than a second width of the second isolation region, and
wherein the first isolation region is formed to have a second thickness in the depth direction greater than a third thickness of the second isolation region.

13. A method of forming a package including a field emission element, the method comprising:
forming a doped region at a surface of a silicon substrate to be doped with dopants;
arranging mask patterns in regions of the doped region;
forming, by etching the doped region, a plurality of probes to be arranged in groups in the regions and arranged along a first axial direction and a second axial direction of the silicon substrate;
forming an isolation region between the groups of probes;
forming an insulating layer to surround the plurality of probes; and
forming a gate electrode at an upper surface of the insulating layer.

14. The method of claim 13, wherein the doped region is formed to have a first thickness, and
wherein the isolation region is formed to extend into the doped region and the silicon substrate in a depth direction to have a second thickness greater than the first thickness.

15. The method of claim 14, wherein the doped region is doped with dopants of a conductive type different from that of the silicon substitute, and
wherein the forming of the isolation region comprises:
forming a trench structure that extends into the doped region in the depth direction to have the second thickness, and
filling the trench structure with an insulating material.

16. The method of claim 15, wherein the silicon substrate is formed as a p-type silicon substrate doped with p-type dopants at a first dopant concentration,
wherein the doped region is formed as an n-type doped region doped with n-type dopants at a second dopant concentration,
wherein the isolation region is doped with p-type dopants at a third dopant concentration, and
wherein the third concentration is higher than the second dopant concentration.

17. The method of claim 13 further comprising, after the forming of the gate electrode:
doping the plurality of probes with n-type dopants,
wherein the doped region formed during the forming of the doped region includes a p- layer having a p-type dopant concentration lower than that of the silicon substrate,
wherein the plurality of probes is formed to have the same conductivity type as either the p- layer in the doped region or the silicon substrate, and
wherein the plurality of probes is formed in such a manner that an n-type dopant concentration of each of the upper regions thereof is higher than that of an n layer region beneath the insulating layer.

18. The method of claim 13, wherein the forming of the doped region comprises:
forming a first semiconductor layer on top of the silicon substrate doped with p-type dopants at a fourth dopant concentration lower than a first dopant concentration of the silicon substrate;
forming an intrinsic semiconductor layer on top of the first semiconductor layer; and
forming a third semiconductor layer on top of the intrinsic semiconductor layer doped with n-type dopants at a second dopant concentration,
wherein the second dopant concentration is higher than the first dopant concentration, and
wherein the plurality of probes is formed in such a manner that an n-type dopant concentration of each of the upper regions thereof is higher than that of each of the lower regions thereof.

19. The method of claim 13, wherein:
the isolation region is formed to have a width in a range from 1 μm to 1 mm,
the isolation region is formed to have a second thickness in a range from 1 nm to 100 μm, and
the width of the isolation region is greater than the second thickness of the isolation region, and
wherein the plurality of probes comprises a first probe region adjacent to one boundary of the isolation region and a second probe region adjacent to an other boundary of the isolation region, and
wherein a width of the isolation region is less than a distance between adjacent probes in the first and second probe regions.

20. The method of claim 13, wherein the forming of the isolation region comprises:
forming a first isolation region at a central region of the silicon substrate; and
forming a second isolation region at a surrounding region of the silicon substrate,
wherein the first isolation region is formed to have a first width greater than a second width of the second isolation region, and
wherein the first isolation region is formed to have a second thickness in the depth direction greater than a third thickness of the second isolation region.
